(19) United States
(12) Patent Application Publication
(10) Pub. No.: US 2025/0232478 A1
(43) Pub. Date: Jul. 17, 2025

(54) FEATURE ADAPTIVE V-DMC SUBDIVISIONS AND TESSELLATIONS

(71) Applicant: Nokia Technologies Oy, Espoo (FI)

(72) Inventors: Patrice RONDAO ALFACE, Antwerp (BE); Lukasz KONDRAD, Munich (DE); Lauri Aleksi ILOLA, Tampere (FI); Aleksei MARTEMIANOV, Tampere (FI)

(21) Appl. No.: 19/015,869

(22) Filed: Jan. 10, 2025

Related U.S. Application Data
(60) Provisional application No. 63/619,970, filed on Jan. 11, 2024.

(51) Int. Cl. G06T 9/00; G06T 9/20

(52) U.S. Cl. CPC G06T 9/001; G06T 9/20

(57) ABSTRACT

An apparatus configured to: obtain a bitstream comprising a mesh sequence of an object or a scene; determine a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; determine a patch associated with the mesh sequence; and decode, from or along the bitstream, the mesh sequence of the image or the video, based on the subdivision iteration count for the at least one primitive of the mesh sequence of the image or the video.

### TECHNICAL FIELD

The examples and non-limiting embodiments relate generally to multimedia transport and, more particularly, to feature adaptive V-DMC subdivisions and tessellations.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 shows an encoder and reconstruction format conversion from an input dynamic mesh sequence to a V3C bitstream and substreams of the V3C bitstream.

FIG. 2 shows a decoder scheme showing the substream decoding and reconstructions process to output a reconstructed dynamic mesh sequence.

FIG. 3 shows the concept of level of detail (LOD) in V-DMC.

FIG. 4 a lifting scheme at the decoder side.

FIG. 5 shows an input base mesh (left), a subdivision patch structure (center), and a final rendered model (right).

FIG. 6 shows transition triangle connectivity for triangles with edges that have different subdivision iteration counts when the subdivision iteration count difference is smaller or equal to one.

FIG. 7 shows three types of feature point locations on a base mesh, including a vertex case/class (left), an edge case (center), and a triangle case (right).

FIG. 8 shows three cases occurring with a feature point on an edge v0v1 with midpoint m01.

FIG. 9 shows feature adaptive subdivision for an edge v0v1 with midpoint m01, connecting triangles v0v1v2 and v0v1v3.

FIG. 10 shows feature adaptive subdivision with a difference of two iterations for the three types of feature point locations on a basemesh, including vertex-based feature adaptive subdivision (left), edge-based feature adaptive subdivision (center), and triangle-based feature adaptive subdivision (right).

FIG. 11 shows feature adaptive subdivision with a difference of one iteration for the three types of feature points locations on a basemesh, including vertex-based feature adaptive subdivision (left), edge-based feature adaptive subdivision (center), and triangle-based feature adaptive subdivision (right).

FIG. 12 shows feature line adaptive subdivision for consecutive feature points sharing a primitive.

FIG. 13 shows feature line adaptive subdivision for consecutive feature points not sharing a primitive.

FIG. 14 shows displacement sorted by LOD level for feature groups fg0 and fg1 with 4 and 5 subdivision iteration counts respectively, while the mesh patch iteration count is set to 2, where the relative size of displacements for LODs 3, 4 and 5 that are specific to the feature-adaptive subdivision is significantly reduced.

FIG. 15 is a block diagram illustrating a system in accordance with an example.

FIG. 16 is an example apparatus configured to implement the examples described herein.

FIG. 17 shows a representation of an example of non-volatile memory media used to store instructions that implement the examples described herein.

FIG. 18 is an example method, based on the examples described herein.

FIG. 19 is an example method, based on the examples described herein.

FIG. 20 is an example method, based on the examples described herein.

### DETAILED DESCRIPTION OF EXAMPLE EMBODIMENTS

### Volumetric Video

There are many ways to capture and represent a Volumetric frame. The format used to capture and represent it depends on the processing to be performed on it, and the target application using it. Some exemplary representations are listed below (1-3):

1. A volumetric frame can be represented as a point cloud. A point cloud is a set of unstructured points in 3D space, where each point is characterized by its position in a 3D coordinate system (e.g. Euclidean), and some corresponding attributes (e.g. color information provided as RGBA value, or normal vectors).

2. A volumetric frame can be represented as images, with or without depth, captured from multiple viewpoints in 3D space. In other words, it can be represented by one or more view frames (where a view is a projection of a volumetric scene on to a plane (the camera plane) using a real or virtual camera with known/computed extrinsic and intrinsic).

Each view may be represented by a number of components (e.g. geometry, color, transparency, and occupancy picture), which may be part of the geometry picture or represented separately.

3. A volumetric frame can be represented as a mesh. Mesh is a collection of points, called vertices, and connectivity information between vertices, called edges. Vertices along with edges form faces. The combination of vertices, edges and faces can uniquely approximate shapes of objects.

Depending on the capture, a volumetric frame can provide viewers the ability to navigate a scene with six degrees of freedom, i.e. both translational and rotational movement of their viewing pose (which includes yaw, pitch, and role). The data to be coded for a volumetric frame can also be significant, as a volumetric frame can contain many objects, and the positioning and movement of these objects in the scene can result in many dis-occluded regions. Furthermore, the interaction of light and materials in objects and surfaces in a volumetric frame can generate complex light fields that can produce texture variations for even a slight change of pose.

A sequence of volumetric frames is a volumetric video. Due to large amount of information, storage and transmission of a volumetric video requires compression. A way to compress a volumetric frame can be to project the 3D geometry and related attributes into a collection of 2D images along with additional associated metadata. The projected 2D images can then be coded using 2D video and image coding technologies, for example ISO/IEC 14496-10 (H.264/AVC) and ISO/IEC 23008-2 (H.265/HEVC). The metadata can be coded with technologies specified in specification such as ISO/IEC 23090-5. The coded images and the associated metadata can be stored or transmitted to a client that can decode and render the 3D volumetric frame.

### Visual Volumetric Video-Base Coding (V3C)—ISO/IEC 23090-5

ISO/IEC 23090-5 specifies the syntax, semantics, and process for coding volumetric video. The specified syntax is designed to be generic so that it can be reused for a variety of applications. Point clouds, immersive video with depth, and mesh representations can all use ISO/IEC 23090-5 standard with extensions that deal with the specific nature of the final representation. The purpose of the specification is to define how to decode and interpret the associated data (for example atlas data in ISO/IEC 23090-5) which tells a renderer how to interpret 2D frames to reconstruct a volumetric frame.

Two applications of V3C (ISO/IEC 23090-5) have been defined, V-PCC (ISO/IEC 23090-5) and MIV (ISO/IEC 23090-12). MIV and V-PCC use number of V3C syntax elements with a slightly modified semantics. An example on how the generic syntax element can be differently interpreted by the application is pdu_projection_id.

In case of V-PCC the syntax element, pdu_projection_id specifies the index of the projection plane for the patch. There can be 6 or 18 projection planes in V-PCC, and they are implicit, i.e. pre-determined.

In case of MIV pdu_projection_id corresponds to a view ID, i.e. identifies which view the patch originated from. View IDs and their related information is explicitly provided in MIV view parameters list and may be tailored for each content.

MPEG 3DG (ISO SC29 WG7) group has started work on a third application of V3C—the mesh compression. It is also envisaged that mesh coding will re-use V3C syntax as much as possible and can also slightly modify the semantics.

To differentiate between applications of V3C bitstream, that allow a client to properly interpret the decoded data, V3C uses the ptl_profile_toolset_idc parameter.

### V3C—V3C Bitstream

V3C bitstream is a sequence of bits that forms the representation of coded volumetric frames and the associated data making one or more coded V3C sequences (CVS). Where CVS is a sequence of bits identified and separated by appropriate delimiters, and is required to start with a VPS, includes a V3C unit, and contains one or more V3C units with atlas sub-bitstream or video sub-bitstream. Video sub-bitstreams and atlas sub-bitstreams can be referred to as V3C sub-bitstreams. Which V3C sub-bitstream a V3C unit contains and how to interpret it is identified by a V3C unit header in conjunction with VPS information.

V3C bitstream can be stored according to Annex C of ISO/IEC 23090-5 which specifies syntax and semantics of a sample stream format to be used by applications that deliver some or all of the V3C unit stream as an ordered stream of bytes or bits within which the locations of V3C unit boundaries need to be identifiable from patterns in the data.

### Video-Based Point Cloud Compression (V-PCC)—ISO/IEC 23090-5

The generic mechanism of V3C may be used by applications targeting volumetric content. One of such application is video-based point cloud compression (ISO/IEC 20390-5). V-PCC enables volumetric video coding for applications in which a scene is represented by point cloud. V-PCC uses the patch data unit concept from V3C and for each patch assign one of 6 (18) pre-defined orthogonal camera views for reprojection.

### MPEG Immersive Video (MIV)—ISO/IEC 23090-12

Another application of V3C is MPEG immersive video (ISO/IEC 23090-12). MIV enables volumetric video coding for applications in which a scene is recorded with multiple RGB(D) (red, green, blue, and optionally depth) cameras with overlapping fields of view (FoVs). One example setup is a linear array of cameras pointing towards a scene. This multi-scopic view of the scene allows a 3D reconstruction and therefore 6DoF/3DoF+ consumption.

MIV uses the patch data unit concept from V3C and extends it by allowing using application specific camera views for reprojection. In contrast to V-PCC, which uses pre-defined 6 or 18 orthogonal camera views for reprojection. Additionally, MIV introduces additional occupancy packing modes and other improvements to V3C base syntax. One such example is support for multiple atlases, for example when there is too much information to pack everything in a single video frame. It also adds support for common atlas data, which contains information that is shared between all atlases. This is particularly useful for storing camera details of the input camera models, which are frequently shared between different atlases.

### Video-Based Dynamic Mesh Coding (V-DMC)—ISO/IEC 23090-29

V-DMC (ISO/IEC 23090-29) is another application form of V3C that aims on integration of mesh compression into the V3C family of standards. The standard is under development and at WD stage (MDS22775_WG07_N00611)

The retained technology after the CfP result analysis is based on multiresolution mesh analysis and coding. This approach consists of (1-6):

1. generating a base-mesh that is a simplified (low resolution) mesh approximation of the original mesh, called base-mesh (this is done for all frames of the dynamic mesh sequence).

2. performing several mesh subdivision iterative steps (e.g., each triangle is converted into four triangles by connecting the triangle edge midpoints on the generated base mesh, generating other approximation meshes

3. defining displacement vectors, also named error vectors, for each vertex of each mesh approximation.

4. For each subdivision level by adding the displacement vectors to the subdivided mesh vertices generates the best approximation of the original mesh at that resolution, given the base-mesh and prior subdivision levels.

5. The displacement vectors may undergo a lazy wavelet transform prior to compression.

6. The attribute map of the original mesh is transferred to the deformed mesh at the highest resolution (i.e., subdivision level) such that texture coordinates are obtained for the deformed mesh and a new attribute map is generated.

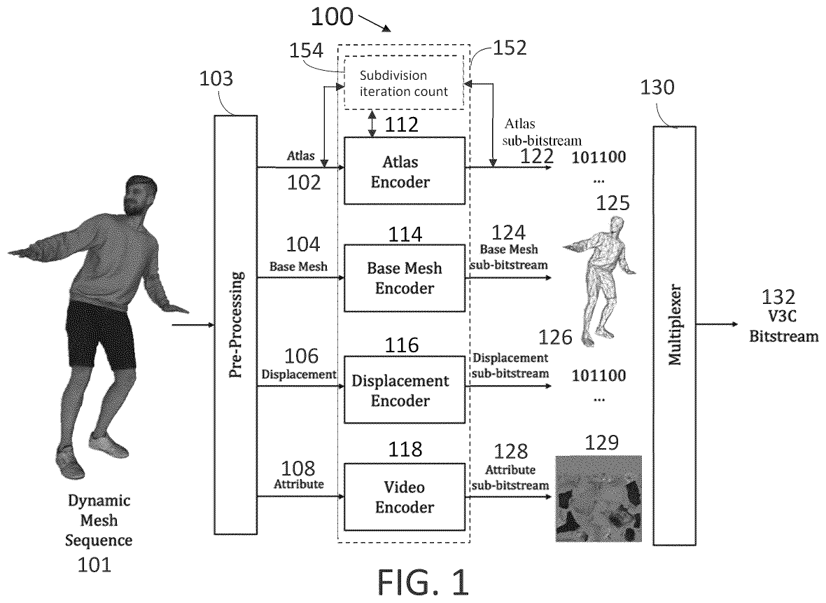

FIG. 1 shows an encoder 100 and reconstruction format conversion from an input dynamic mesh sequence 101 to a V3C bitstream 132 and its substreams.

Encoding 152 includes atlas encoder 112, base mesh encoder 114, displacement encoder 116, video encoder 118, and a subdivision iteration count value or parameter 154. The subdivision iteration count value or parameter 154 may be used to determine a subdivision iteration count based on at least one primitive (e.g. vertex, edge, line, face, etc.), based on the examples described herein. The subdivision iteration count value or parameter 154 is part of the atlas metadata, thus the subdivision iteration count value or parameter 154 is coupled to the atlas 102 and atlas sub-bitstream 122, and to atlas encoder 112.

The V-DMC encoder 100 generates that compressed bitstreams (122, 124, 126, 128), which later on are packed in V3C units and create V3C bitstream 132 by concatenating V3C units as illustrated on FIG. 1: A sub-bitstream (124) with the encoded base-mesh 125 using a mesh codec, a sub-bitstream (126) with the displacement vectors: packed in an image and encoded using a video codec, or arithmetic encoded as defined in Annex J of WD ISO/IEC 23090-29, a sub-bitstream (128) with the attribute map 129 encoded using a video codec, and a sub-bitstream 122 (atlas) that contains all metadata required to decode and reconstruct the mesh sequence based on the aforementioned sub-bitstreams. The signaling of the metadata is based on the V3C syntax and includes necessary extensions that are specific to meshes.

As shown in FIG. 1, pre-processing 103 obtains as input the dynamic mesh sequence 101, and generates the atlas 102, base mesh 104, displacement 106, and attribute data 108. Atlas encoder 112 uses atlas 102 to generate atlas sub-bitstream 122, base mesh encoder 114 uses base mesh 104 to generate base mesh sub-bitstream 124 with the encoded base-mesh 125, displacement encoder 116 uses displacement 106 to generate displacement sub-bitstream 126, and video encoder 118 uses attribute data 108 to generate attribute sub-bitstream 128 with the attribute map 129. Multiplexer generates V3C bitstream 132 using atlas sub-bitstream 122, base mesh sub-bitstream 124 with the encoded base-mesh 125, displacement sub-bitstream 126, and attribute sub-bitstream 128 with the attribute map 129.

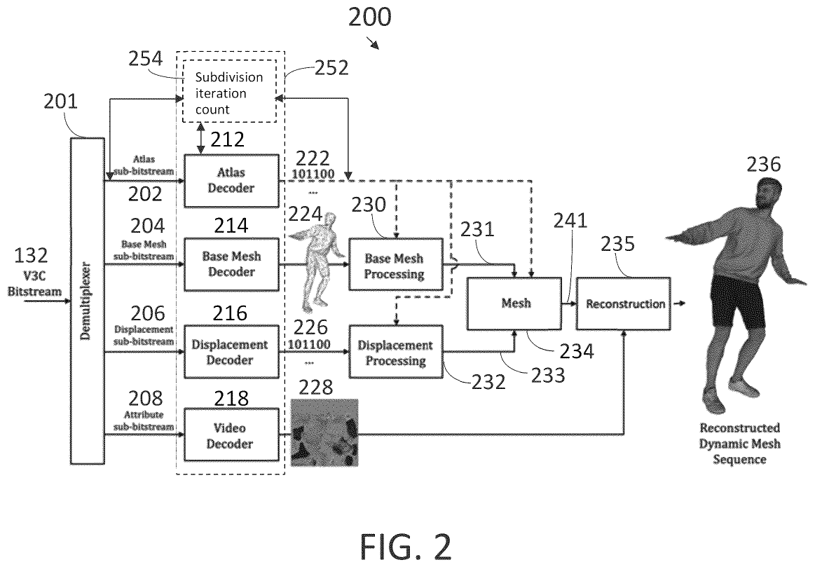

The reconstruction process that produces a reconstructed dynamic mesh sequence is also shown in FIG. 2. FIG. 2 shows a decoder 200 and decoder scheme showing the substream decoding and reconstruction process to output a reconstructed dynamic mesh sequence 236. Thus, FIG. 2 provides the V-DMC decoder scheme, where the V-DMC substreams are independently decoded generating: decoded atlas data 222, base mesh reconstructed data 224 and its processing 230, decoded displacement data 226 and its processing 232 and decoded attribute data 228.

Decoding 252 includes atlas decoder 212, base mesh decoder 214, displacement decoder 216, video decoder 218, and a subdivision iteration count value or parameter 254. The subdivision iteration count value or parameter 254 may be used to determine a subdivision iteration count based on at least one primitive (e.g. vertex, edge, line, face, etc.), based on the examples described herein. The subdivision iteration count value or parameter 254 is part of the atlas metadata, thus the subdivision iteration count value or parameter 254 is coupled to atlas sub-bitstream 202 and decoded atlas data 222, and to atlas decoder 212.

As shown in FIG. 2, demultiplexer 201 takes as input V3C bitstream 132 and generates atlas sub-bitstream 202, base mesh sub-bitstream 204, displacement sub-bitstream 206, and attribute sub-bitstream 208. Atlas decoder 212 uses atlas sub-bitstream 202 to generate decoded atlas data 222. Base mesh decoder 214 uses base mesh sub-bitstream 204 to generate base mesh reconstructed data 224. Displacement decoder 216 uses displacement sub-bitstream to generate decoded displacement data 226. Video decoder 218 uses attribute sub-bitstream 208 to generate decoded attribute data 228.

Base mesh processing 230 takes as input decoded atlas data 222 and base mesh reconstructed data 224 to generate output 231 used with mesh 234. Displacement processing 232 takes as input decoded atlas data 222 and decoded displacement data 226 to generate output 233 used with mesh 234. Mesh 234 uses decoded atlas data 222, output 231 and output 233 to generate output 241 used as input with reconstruction 235 to generate the reconstructed dynamic mesh sequence 236.

### Base-Mesh Bitstream (ISO/IEC 23090-29)

An elementary unit for the output of an base-mesh encoder (Annex H of ISO/IEC 23090-29) is a NAL unit.

A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units can be categorized into Base-mesh Coding Layer (BMCL) NAL units and non-BMCL NAL units. BMCL NAL units can be coded sub-mesh NAL units. A non-BMCL NAL unit may be for example one of the following types: a base-mesh sequence parameter set, a base-mesh frame parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded bas-mesh, whereas many of the other non-BMCL NAL units are not necessary for the reconstruction of decoded sample values.

V-DMC specifications may contain a set of constraints for associating data units (e.g. NAL units) into coded base-mesh access units.

As is best understood, there is no definition of the coded base-mesh access unit in WD of the V-DMC specification.

### Atlas Data (ISO/IEC 23090-29)

The V-DMC standard provides semantic and signaling information that is required to process the decoded V-DMC substreams. The Atlas sequence parameter set is detailed in the following table. It contains information on the subdivision parameters, displacement coordinates, transform parameters, number and parameters of the video attributes, etc.

### 8.3.6.1.3 Atlas Sequence Parameter Set V-DMC Extension Syntax

| | De- |
|---|---|
| | scriptor |
| asps_vdmc_extension( ) { | |
| asve_subdivision_method | u(3) |
| if(asve_subdivision_method != 0) { | |
| asve_subdivision_iteration_count | u(8) |
| AspsSubdivisionCount = | |
| asve_subdivision_iteration_count | |
| } else | |
| AspsSubdivisionCount = 0 | |
| asve_displacement_coordinate_system | u(1) |
| asve_1d_displacement_flag | u(1) |
| asve_transform_method | u(3) |
| if(asve_transform_method == LINEAR_LIFTING) { | |
| vdmc_lifting_transform_parameters( 0, | |
| AspsSubdivisionCount ) | |
| } | |
| asve_num_attribute_video | u(7) |
| for(i=0; i< asve_num_attribute_video; i++){ | |
| asve_attribute_type_id[ i ] | u(8) |
| asve_attribute_frame_width[ i ] | ue(v) |
| asve_attribute_frame_height[ i ] | ue(v) |
| asve_attribute_subtexture_enabled_flag[ i ] | u(1) |
| } | |
| asve_packing_method | u(1) |
| asve_projection_textcoord_enable_flag | u(1) |
| if( asve_projection_textcoord_enable_flag ){ | |
| asve_projection_textcoord_mapping_method | u(2) |
| asve_projection_textcoord_scale_factor | fl(64) |
| } | |
| asve_displacement_frame_qp_minus_N | u(7) |
| } | |

Atlas tile information is provided in the following.

| | De- |
|---|---|
| | scriptor |
| atlas_frame_attribute_tile_information( attrIdx ) { | |
| afati_single_tile_in_atlas_frame_flag[ attrIdx ] | u(1) |
| if( !afati_single_tile_in_atlas_frame_flag[ attrIdx ] ) { | |
| afati_uniform_partition_spacing_flag[ attrIdx ] | u(1) |
| if( afati_uniform_partition_spacing_flag[ attrIdx ] ) { | |
| afati_partition_cols_width_minus 1 [ attrIdx ] | ue(v) |
| afati_partition_rows_height_minus1[ attrIdx ] | ue(v) |
| } else { | |
| afati_num_partition_columns_minus1 [ attrIdx ] | ue(v) |
| afati_num_partition_rows_minus1[ attrIdx ] | ue(v) |
| for( i = 0; i < afati_num_partition_columns_minus1[ | |
| attrIdx ]; i++ ) | |
| afati_partition_column_width_minus1[ attrIdx ][ i ] | ue(v) |
| for( i = 0; i < afati_num_partition_rows_minus1[ attrIdx ]; | |
| i++ ) | |
| afati_partition_row_height_minus1[ attrIdx ][ i ] | ue(v) |
| } | |
| afati_single_partition_per_tile_flag[ attrIdx ] | u(1) |
| if( !afati_single_partition_per_tile_flag[ attrIdx ] ) { | |
| afati_num_tiles_in_atlas_frame_minus1[ attrIdx ] | ue(v) |
| for( i = 0; i < afati_num_tiles_in_atlas_frame_minus1[ | |
| attrIdx ] + 1; i++ ) { | |
| afati_top_left_partition_idx[ attrIdx ][ i ] | u(v) |
| afati_bottom_right_partition_column_offset[ attrIdx ][ i ] | ue(v) |
| afati_bottom_right_partition_row_offset[ attrIdx ][ i ] | ue(v) |
| } | |
| } | |
| else | |
| afati_num_tiles_in_atlas_frame_minus1[ attrIdx ]= | |
| NumAttributePartitionsInAtlasFrame[ attrIdx ] − 1 | |
| } | |
| else | |
| afati_num_tiles_in_atlas_frame_minus1 [ attrIdx ] = 0 | |
| afati_signalled_tile_id_flag[ attrIdx ] | u(1) |
| if( afati_signalled_tile_id_flag[ attrIdx ] ) { | |
| afati_signalled_tile_id_length_minus1 [ attrIdx ] | ue(v) |
| for( i = 0; i < afati_num_tiles_in_atlas_frame_minus1[ | |
| attrIdx ] + 1; i++ ) { | |
| afati_tile_id[ attrIdx ][ i ] | u(v) |
| TileIDToIndexAtt[ attrIdx ][ afati_tile_id[ a ][ i ] ] = i | |
| TileIndexToIDAtt[ attrIdx ][ i ] = afati_tile_id[ a ][ i ] | |
| } | |
| } else { | |
| for( i = 0; i < afati_num_tiles_in_atlas_frame_minus1[ | |
| attrIdx ] + 1; i++ ) { | |
| afati_tile_id[ attrIdx ][ i ] = i | |
| TileIDToIndexAtt[ attrIdx ][ i ] = i | |
| TileIndexToIDAtt[ attrIdx ][ i ] = i | |
| } | |
| } | |
| } | |

### Subdivision and Lifting Transform (ISO/IEC 23090-29)

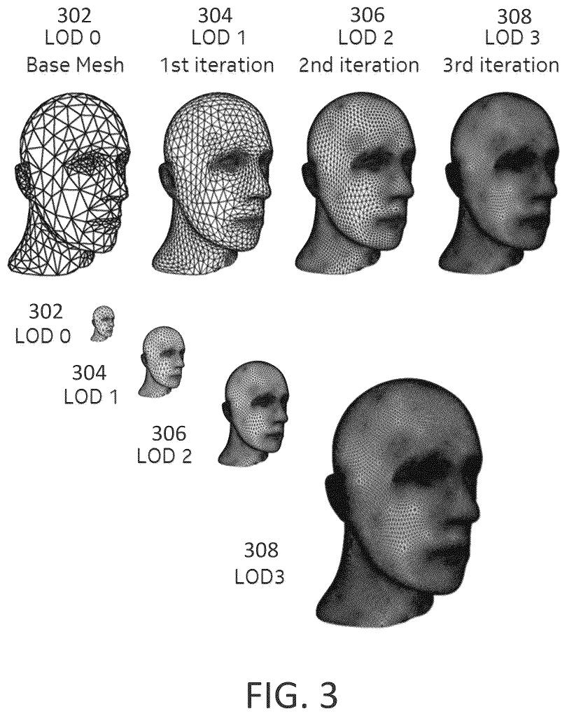

The V-DMC framework utilizes the well-known concept of Level-of-Detail (LoD). FIG. 3 shows the concept of Level of Detail (LOD) in V-DMC: higher resolution (LOD2 306 or LOD3 308) is required for rendering from a close distance, while lower resolution (LOD0 302, LOD1 304) is sufficient for far distances. More LODs enable better tradeoffs between rendering performance and perceived quality of details.

As illustrated on FIG. 3, different LoD levels correspond to different sampling rates and qualities of meshes. It is desirable to process different LoD levels on a GPU for example for rendering, to optimize rendering speed. For example, when the mesh is rendered at a far distance in the viewport, it only is represented by a small number of pixels, and a coarse mesh representation (lowest LoD level) is sufficient as finer sampling rates of the mesh would not lead to a better quality. When the mesh is rendered at a close distance in the viewport, then it is desirable to view it in full resolution (highest LoD level) to maximize rendering quality. In between these cases, the LoD level can be optimized based on the area of the viewport that would be occupied by the mesh, and it is therefore desirable to represent the mesh in several LoDs for interactive rendering applications.

In V-DMC, typically 3, but can be more, LoD levels are defined, but some rendering applications may use for example up to 18 LoD levels. A given LoD level is generated from the previous LoD reconstruction by using a subdivision iteration and applying reconstructed displacement data as explained before.

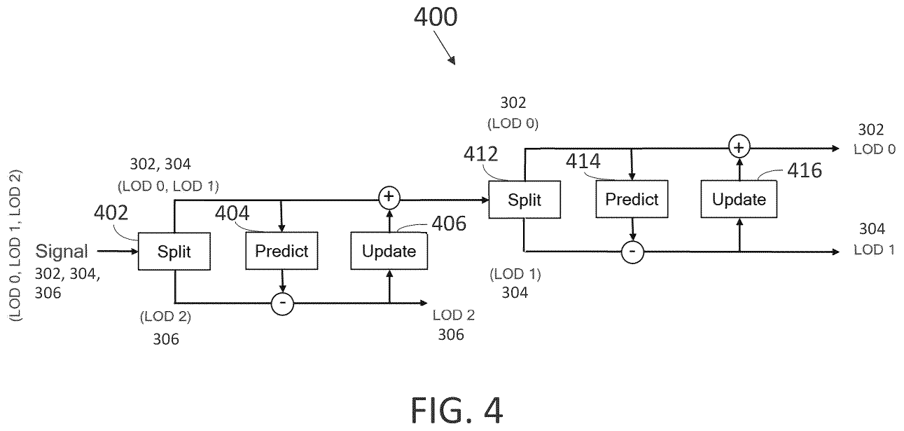

The V-DMC framework further uses a lifting transform to decorrelate the signal defined on the mesh connectivity at each LOD in a hierarchical manner; the signal being the displacements and the normal, but can also include other attributes for example. The way the lifting operations predict a LOD from a lower resolution is illustrated on FIG. 4. Thus FIG. 4 shows the lifting scheme 400 at the decoder side.

The lifting scheme 400 in V-DMC enables to reduce the redundancy present across LODs. The predict step (404, 414) for a signal at vertex v located at the midpoint of the edge v0v1 from the lower LOD i is defined as follows:

$$Predict ( signal [ v ] ) = predWeights [ i ] ( signal [ v 0 ] + signal [ v 1 ] )$$

Where predWeights are the prediction weights defined for LOD i and are typically set to a value of 0.5. The update step (406, 416) is provided as follows:

$$Update ( signal [ v ] ) = \sum vi ∈ v ⋆ udpateWeights [ i ] signal [ vi ]$$

Where updateWeights may be set differently per LOD and where v* is the vertex neighborhood of vertex v at the same LOD as v.

The variables updateWeights and predictWeights are signaled in the vdmc_lifting_transform_parameters as shown in the next table:

| | Descriptor |
|---|---|
| vdmc_lifting_transform_parameters( ltpIndex, subdivisionCount ){ | |
| vltp_skip_update_flag[ ltpIndex ] | u(1) |
| vltp_adaptive_quantization_enabled_flag[ ltpIndex ] | u(1) |
| vltp_lod_quantization_flag[ ltpIndex ] | u(1) |
| vltp_bitdepth_offset[ ltpIndex ] | se(v) |
| if( vltp_lod_quantization_flag[ ltpIndex ] == 0 ) { | |
| for( k = 0; k < DisplacementDim; k++) { | |
| if( vltp_adaptive_quantization_enabled_flag[ ltpIndex ] ) { | |
| vltp_scale_factors[ ltpIndex ][ k ] | ue(v) |
| } else { | |
| vltp_quantization_parameters[ ltpIndex ][ k ] | ue(v) |
| vltp_log2_lifting_lod_inverse_scale[ ltpIndex ][ k ] | u(2) |
| } | |
| } | |
| } else { | |
| for( i=0 ; i < subdivisionCount + 1; i++ ) { | |
| for( k = 0; k < DisplacementDim; k++ ) { | |
| if( vltp_adaptive_quantization_enabled_flag[ ltpIndex ] ) { | |
| vltp_lod_delta_scale[ ltpIndex ][ i ][ k ] | u(6) |
| if( vltp_lod_delta_scale[ ltpIndex ][ i ][ k ] ) | |
| vltp_lod_delta_scale_sign[ ltpIndex ][ i ][ k ] | u(1) |
| } else { | |
| vltp_lod_delta_qp [ ltpIndex ][ i ][ k ] | u(6) |
| if ( vltp_lod_delta_qp[ ltpIndex ][ i ][ k ] ) | |
| vltp_lod_delta_qp_sign[ ltpIndex ][ i ][ k ] | u(1) |
| } | |
| } | |
| } | |
| } | |
| for( i=0 ; i < subdivisionCount + 1; i++ ) { | |
| if( vltp_lod_quantization_flag[ ltpIndex ] == 1 ∥ i == 0) { | |
| vltp_log2_lifting_update_weight[ ltpIndex ][ i ] | ue(v) |
| vltp_log2_lifting_prediction_weight[ ltpIndex ][ i ] | ue(v) |
| } else { | |
| vltp_log2_lifting_update_weight[ ltpIndex ][ i ] = | |
| vltp_log2_lifting_update_weight[ ltpIndex ][ 0 ] | |
| vltp_log2_lifting_prediction_weight[ ltpIndex ][ i ] = | |
| vltp_log2_lifting_prediction_weight[ ltpIndex ][ 0 ] | |
| } | |
| } | |
| } | |

vltp_log2_lifting_update_weight[ltpIndex][i] indicates the weighting coefficients used for the update filter of the wavelet transform of the ith level of details. ltpIndex is the index of the lifting transform parameter set.

vltp_log2_lifting_prediction_weight[ltpIndex][i] the weighting coefficients used for the prediction filter of the wavelet transform of the ith level of details. ltpIndex is the index of the lifting transform parameter set.

Also shown in FIG. 4 are the split steps (402, 412). Split 402 splits the signal comprising LOD 0 302, LOD 1 304, and LOD 2 306 into (LOD 0 302, LOD 1 304) and (LOD 2 306). Split 412 splits (LOD 0 302, LOD 1 304) into (LOD 0 302) and (LOD 1 304).

Examples related to adaptive subdivision for video-based dynamic mesh coding handle transition triangles with subdivision iteration count differences between edges that may be larger than two. However, these examples do not address the feature adaptive or coding aspects described herein.

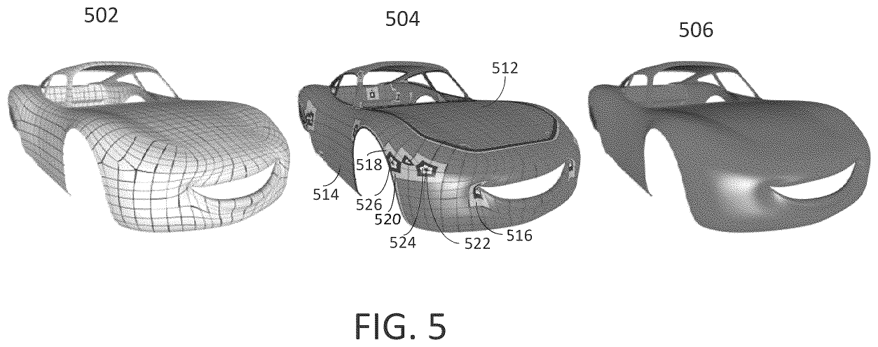

Increasing the number of LODs exponentially increases the number of output triangles and quickly reduces the rendering performance because triangles are created everywhere even if displacement information is equal to zero. In practice, it is important to add displacements and to increase the mesh resolution where it matters, such as in feature regions, feature lines (called creases) and feature points (see FIG. 5).

FIG. 5 shows an input base mesh (502), a subdivision patch structure (504), and a final rendered model (506). In particular, FIG. 5 shows feature adaptive subdivision or tessellation. Areas in the middle (e.g. area 512, area 514) show areas with small subdivision iteration counts, while feature points and feature lines are highlighted with different shading such as areas (516, 518), to areas (520, 522) blue and areas (524, 526) yellow as the subdivision iteration count progressively increases.

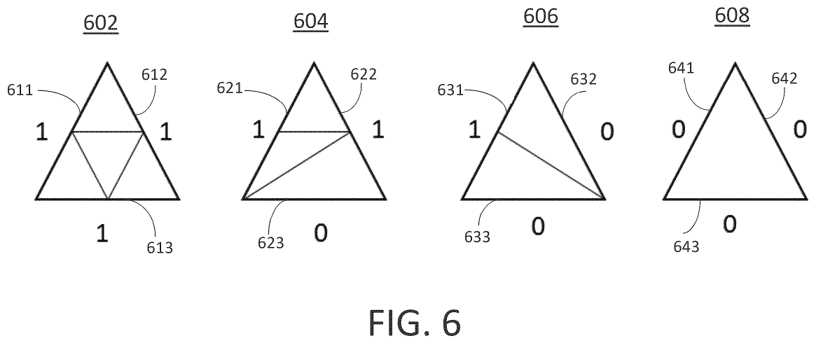

While V-DMC enables to define different subdivision iteration counts for different submeshes, this can only be used at a coarse granularity in terms of subdivision iteration counts and can only be used for feature regions, not feature lines or points. The price to pay is also that zippering must be performed between reconstructed submeshes, and that T-junctions between submeshes need to be avoided by using transition triangles as illustrated on FIG. 6. In particular, FIG. 6 shows transition triangle connectivity for triangles with edges that have different subdivision iteration counts when the subdivision iteration count difference is smaller or equal to one. In FIG. 6, item 602 shows three edges (edge 611, edge 612, edge 613) with a subdivision iteration count equal to one, item 604 shows two edges (edge 621, edge 622) with a subdivision iteration count set to one and the other edge 623 with a subdivision iteration count equal to zero, item 606 shows one edge 631 with a subdivision iteration count set to one and two edges (edge 632, edge 633) with a subdivision iteration count set to zero, and item 608 shows three edges (edge 641, edge 642, edge 643) with a subdivision iteration count set to zero.

Disclosed herein are encoding, signaling, decoding and reconstruction embodiments that allow to increase the subdivision iteration count locally for feature lines and feature points in V-DMC. This is enabled by introducing the concept of feature groups and transition connectivity.

Advantages of this approach is that while V-DMC is typically limited to a maximum of 3 subdivision iterations before reaching too large resolutions, subdivision iteration counts up to 6 or 7 are possible locally while maintaining the mesh resolution adequate for real-time rendering and reaching a higher compression performance.

### 1. Encoding Embodiments

### 1.1 Detecting or Selecting Feature Primitives: Points and Lines

In one embodiment feature primitives such as feature lines and feature points, can be detected by performing a pre-encoding of the original mesh sequence using a V-DMC encore with regular and uniform subdivisions. Points where displacements are locally maximal can be selected as feature points.

Feature primitives, such as points, edges and lines can also be detected by estimating local extrema of the mesh underlying surface curvature, for example creases can be detected and established as a feature line, or points located at the apex of a body part are also excellent candidates as feature points. More approaches can be used, such as relying on computing displacements between the original surface mesh and the same surface mesh being iteratively smoothed; selecting the local maximal values of these displacements is also a valid feature point detector.

In another embodiment, the feature primitives such as feature points may be selected interactively or be provided by the content creator for example.

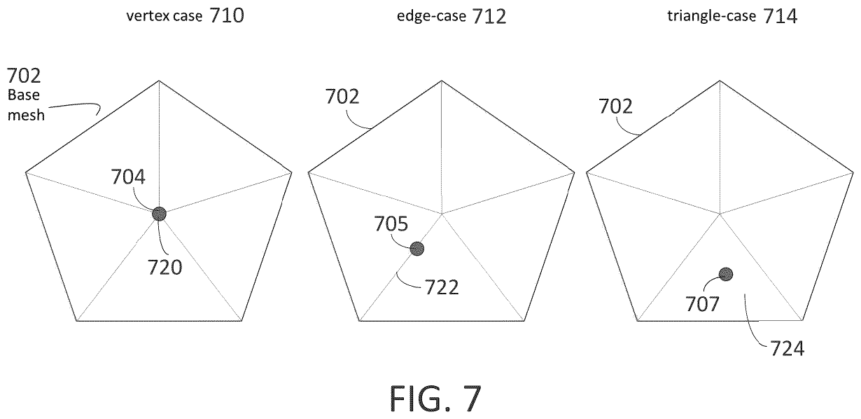

In one embodiment the feature primitive such as a feature point may be on the base mesh surface mesh or outside of it. In the latter case, it can be mapped by nearest neighbor or projected to the base mesh. FIG. 7 illustrates the three cases (for a base mesh 702) when a feature point 704 lies on a base mesh vertex 720 (case 710), or when a feature point 705 lies on a base mesh edge 722 (case 712), or when a feature point 707 lies on a base mesh triangle (case 724), respectively.

Feature primitives such as the feature points and feature edges or lines connecting feature points can be encoded in the base mesh substream using a static mesh codec possibly with an animation codec as well. Feature points are associated with a vertex index that may correspond to a vertex of the base mesh surface or not (the point is not connected to the main base mesh). Edges may be provided to encode the connectivity of feature lines. If feature points and lines are attached to the base mesh substream, they may be used as features for animation and the coding of motion for the base mesh in one particular embodiment.

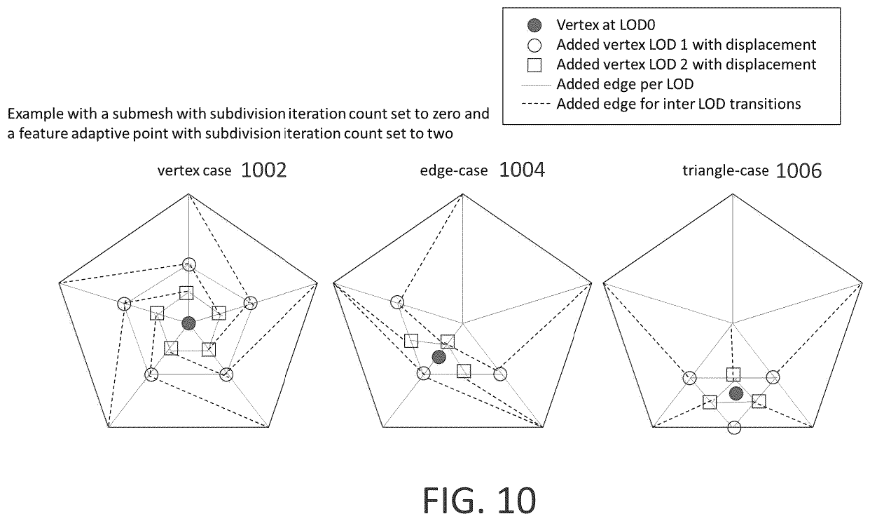

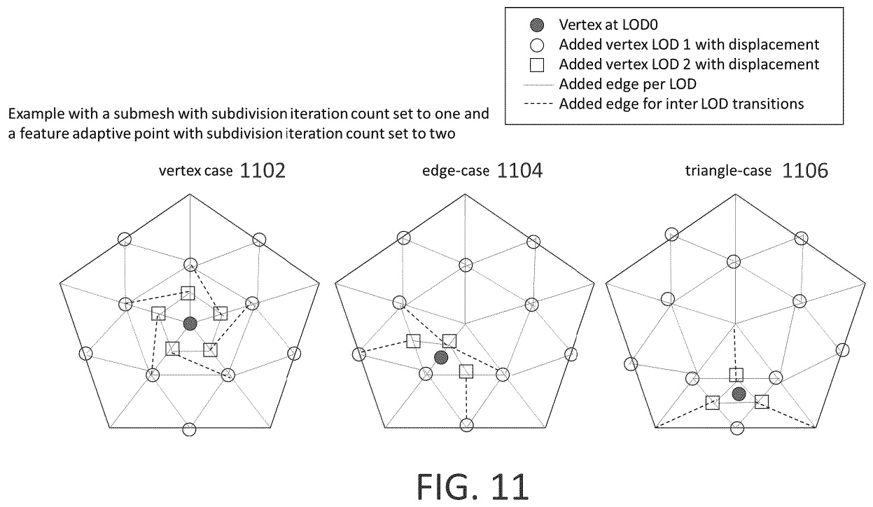

Alternatively, feature primitives such as points may not be encoded in the base mesh directly, but instead, a subdivision iteration may be set in the v-dmc metadata for the group of primitives such as edges or triangles connected to such vertex at a given LOD level, for example, the highest LOD level set for the current submesh. This approach may require more metadata signaling than encoding feature points in the base mesh substream (see for example FIG. 10 and FIG. 11 where edges are processed based on the case/class of the feature point).

### 2. Embodiments Common to Encoding and Decoding

### 2.1 Feature Adaptive Subdivision

In one embodiment, the subdivision process in V-DMC is modified as follows. The feature adaptive subdivision iteration count is performed (or determined) based on primitive types.

### 2.1.1 Face-Granularity Feature Adaptive Subdivision

In one embodiment, the feature adaptive subdivision iteration count is performed at face-granularity, the primitive being face.

The subdivision iteration count tsic (triangles subdivision iteration count) of triangles that are connected to a feature point with subdivision iteration count fpsic is as follows:

tsic=max(fpsic,pdu_subdivision_iteration_count[tileID][patchIdx])

Where pdu_subdivision_iteration_count[tileID][patchIdx] is the signaled subdivision iteration count in a patch that is associated with a given submesh.

Similarly, if the triangle is connected to a number N of feature points with subdivision iteration counts fpsic1 . . . fpsicN the triangle tsic is set as

tsic=max(fpsic1, . . . ,fpsicN,pdu_subdivision_iteration_count[tileID][patchIdx])

In one embodiment, a feature point is said to be connected to a triangle if it is located on one vertex of the triangle.

In another embodiment a feature point is said to be connected to a triangle if its position lies in the interior of the triangle shape including vertices and edges.

Edges belonging to triangles with a different tsic require the triangle with the smaller tsic to be processed as a transition triangle as illustrated on FIG. 6 when the difference in iteration count is equal to one.

For larger differences, the transition triangles may be processed differently.

2.1.2 Edge-, Half-Edge- and/or Oriented-Edge-Granularity Feature Adaptive Subdivision

In one embodiment, the edge v0v1 (i.e. connecting vertex v0 to v1) is considered differently from v1v0 (i.e. connecting vertex v1 to v0), these are called half edges or oriented edges; the subdivision iteration count for v0v1 and v1v0 might be different.

If an edge v0v1 contains one or more feature points with subdivision iteration count fpsic1 . . . fpsicN either at its extremities v0 and/or v1, or at a position in between v0 and v1, then the edge subdivision iteration count esic is

esic=max(fpsic1, . . . ,fpsicN,pdu_subdivision_iteration_count[tileID][patchIdx])

Where pdu_subdivision_iteration_count[tileID][patchIdx] is the signaled subdivision iteration count in a patch that is associated with a given submesh.

The subdivision iteration count tsic for faces that are not connected to an edge with an esic different from pdu_subdivision_iteration_count[tileID][patchIdx] is set to pdu_subdivision_iteration_count[tileID][patchIdx].

Similarly, if one or maximum two edges of a triangle have an esic different from pdu_subdivision_iteration_count[tileID][patchIdx], tsic is still set to pdu_subdivision_iteration_count[tileID][patchIdx].

Only if the three edges of a triangle have a different esic (esic0, esic1 and esic2, respectively) than pdu_subdivision_iteration_count[tileID][patchIdx] then tsic is set to

tsic=min(esic0,esic1,esic2)

Triangles with a triangle tsic being different from one of its edge esic0, esic1, esic2 must be handled as transition triangles as illustrated on FIG. 6. For larger differences, the transition triangles may be processed differently.

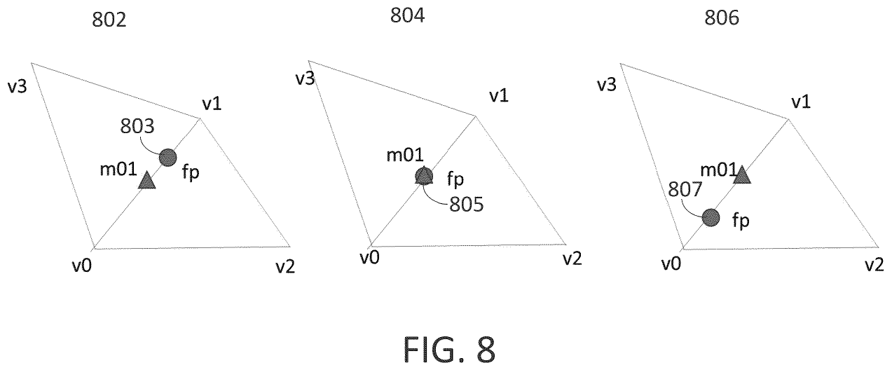

FIG. 8 shows three cases where a feature point is on an edge v0v1 with midpoint m01. Three cases occur and are shown in FIG. 8: on the left (802), the feature point (803) is closer to v1 than to v0, in the middle (804) the feature point (805) is located on m01, on the right (806), the feature point (807) is closer to v0 than to v1.

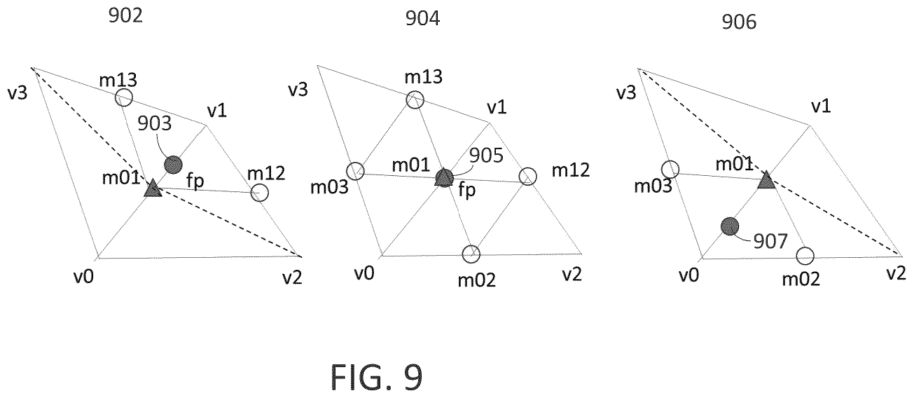

FIG. 9 shows feature adaptive subdivision for an edge v0v1 with midpoint m01, connecting triangles v0v1v2 and v0v1v3.

On the left (902) in FIG. 9, when the feature point (903) is closer to v1 than to v0, two additional vertices are created on midpoints m12 and m13 of edges v1v2 and v1v3, respectively, edges m01m12 and m01m13 are created, edges m01v3 and m01v2 are added as v0v1v2 and v0v1v3 are transition triangles.

In the middle (904) in FIG. 9, when the feature point 905 is located on m01, then four additional vertices are created on midpoints m12, m13, m02 and m03 of edges v1v2, v1v3,v0v2 and v0v3, respectively. Triangles v0v1v2 and v0v1v3 are not transition triangles and do not require additional edges.

On the right (906) in FIG. 9, when the feature point 907 is closer to v0 than to v1, two additional vertices are created on midpoints m02 and m03 of edges v0v2 and v0v3, respectively, edges m01m02 and m01m03 are created, edges m01v3 and m01v2 are added as v0v1v2 and v0v1v3 are transition triangles.

Thus, FIG. 8 and FIG. 9 illustrate the feature adaptive subdivision process for an edge v0v1 with a feature point fp (903, 905, 907).

### 2.1.3 Vertex-Granularity Feature Adaptive Subdivision

Here, for these embodiments, the primitive is a vertex.

When a feature point is located on a vertex, then the subdivision process occurs as illustrated on FIG. 10 and FIG. 11. The vertex-granularity is similar to the edge-granularity in the sense that the process of each edge connected to the feature point vertex is handled as in the edge-granularity feature adaptive subdivision case. The only difference lies in the handling of transition triangles and the necessary additional edges to be added; there is always a choice between two possible additional edges. In one embodiment where there is an additional edge in a transition triangle v0v1v2, where the choice is between connecting a newly created vertex and either triangle vertices v0 or v1, then the triangle vertex with lowest vertex index is chosen. In another embodiment, the vertex with largest vertex index is chosen.

2.1.4 Subdivision Iteration Count Differences Larger than One

In one embodiment, in a triangle, if the difference of subdivision iteration count between edges is larger than one, the feature adaptive process is repeated iteratively following the triangle-edge- or vertex-granularity feature adaptive subdivision until the largest subdivision iteration count is met. This is illustrated on FIG. 10.

FIG. 10 shows examples where the base mesh triangles are assigned a subdivision iteration count equal to zero and the feature point a subdivision iteration count equal to two, while FIG. 11 illustrates the case where the base mesh triangles are assigned a subdivision iteration count equal to one and the feature point a subdivision iteration count equal to two.

In particular, FIG. 10 shows feature adaptive subdivision with a difference of two iterations for the three types of feature point locations on a basemesh, from left to right, vertex-based 1002 (feature point located on a vertex), edge-based 1004 (feature point located on an edge) and triangle-based 1006 (feature point located on a triangle) feature adaptive subdivisions

As detailed before, in one embodiment, all edges that are connected to a feature point may be signaled directly in the vdmc metadata, without using the feature point position in the base mesh. This however implies encoding 5 edges, 3 edges and 3 edges respectively in the FIG. 10 from left to right instead of a single feature point index in the base mesh.

Thus, FIG. 11 shows feature adaptive subdivision with a difference of one iteration for the three types of feature point locations on a basemesh, from left to right, vertex-based 1102 (feature point located on a vertex), edge-based 1104 (feature point located on an edge) and triangle-based 1106 (feature point located on a triangle) feature adaptive subdivisions.

### 2.2 Feature Edges and Lines

Here, for these embodiments, the primitive is an edge (or a plurality of edges) or a line (or a plurality of lines), as the feature adaptive subdivision iteration count is performed (or determined) based on primitive types.

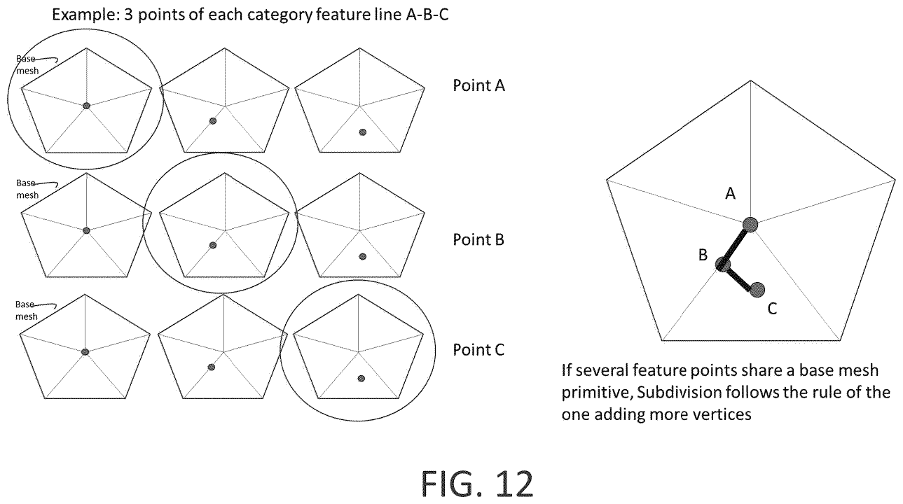

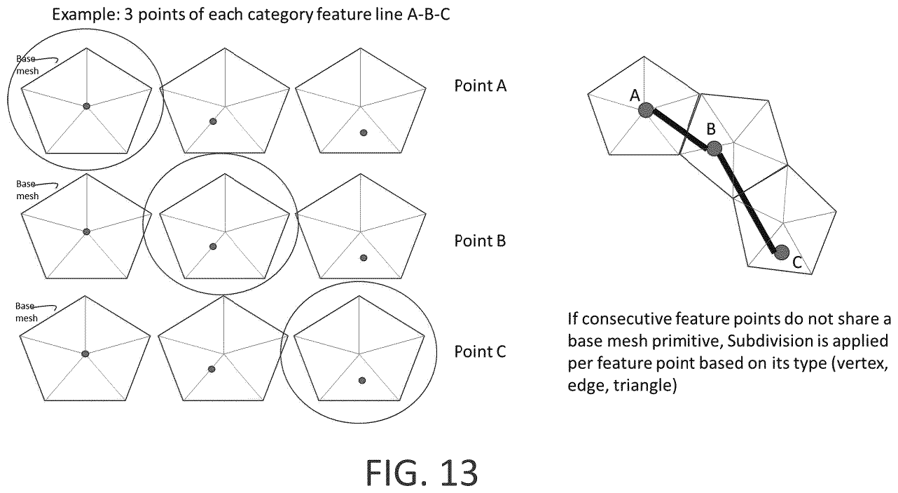

Feature lines are a special case that connect feature points with feature edges. Feature adaptive subdivision rules are the same for feature lines and their feature points. Two cases occur, one where two consecutive feature points in the feature line share a base mesh primitive (triangle, edge or vertex) and when they do not as illustrated on FIG. 12 and FIG. 13. In particular, FIG. 12 shows feature line adaptive subdivision for consecutive feature points sharing a primitive, and FIG. 13 shows feature line adaptive subdivision for consecutive feature points not sharing a primitive.

In FIG. 12, if several features points share a base mesh primitive, subdivision follows the rule of the one adding more vertices. In FIG. 13, if consecutive feature points do not share a base mesh primitive, subdivision is applied per feature point based on the type of feature point (vertex, edge, triangle).

In case feature points of a feature line are connected a common edge or face of the base mesh, then the subdivision process is guided by the granularity yielding the larger amount of additional vertices, which is in decreasing priority: vertex-granularity, edge-granularity and finally face-granularity. Other embodiments may select a different choice of priorities and for example always select the face-granularity or the edge-granularity.

In one embodiment, the decoder does not rely on signaling to identify if a feature point is to be handled as vertex-case, edge-case or face-case, respectively as each case can be simply tested on the decoded base mesh. This reduces metadata overhead. However, in another embodiment, each feature point index could be associated with a flag indicating whether the feature point is to be handled as vertex, edge, or triangle case. This may enable decoder optimizations based on the total number of additional vertices introduced for feature points.

In another embodiment, the total number of additional vertices per group of features (see Section 7.3) and per LOD is signaled along the bitstream and/or in a SEI message.

### 2.3 Lifting Scheme and Feature Points

After subdivision is performed, the lifting scheme may be used to predict LODs from a level to the other as detailed in the Background. The embodiments regarding the subdivision for feature points, feature faces and feature lines are compatible with the lifting scheme as specified in V-DMC. A set of prediction and update weights can be signaled per LOD and could be set to the LODs that relate directly to feature points.

In another embodiment, specific prediction and/or update weights may be defined exclusively for points generated by the subdivision process implied by a feature point.

### 3. Signaling Embodiments

Encoding of feature points and feature lines is performed in the base mesh substream using a static mesh codec and optionally a mesh motion codec.

### Signaling of Feature Adaptive Subdivision Occurs in the Patch Data Unit Syntax Level 8.3.7.3

Additional signaling is given between but not necessarily including pdu_2d_size_y_minus1[tileID][patchIdx] and pdu_parameters_override_flag[tileID][patchIdx]. Thus the additional signaling includes pdu_feature_groups_present_flag[tileID][patchIdx] and pdu_feature_goups_count_minus1[tileID][patchIdx].

| | Descriptor |
|---|---|
| patch_data_unit( tileID, patchIdx ) { | |
| pdu_submesh_id[ tileID ][ patchIdx ] | u(v) |
| pdu_vertex_count_minus1 [ tileID ][ patchIdx ] | ue(v) |
| pdu_face_count_minus1[ tileID ][ patchIdx ] | ue(v) |
| pdu_2d_pos_x[ tileID ][ patchIdx ] | ue(v) |
| pdu_2d_pos_y[ tileID ][ patchIdx ] | ue(v) |
| pdu_2d_size_x_minus1[ tileID ][ patchIdx ] | ue(v) |
| pdu_2d_size_y_minus1[ tileID ][ patchIdx ] | ue(v) |
| pdu_feature_groups_present_flag[ tileID ][ patchIdx ] | u(1) |
| if( pdu_feature_groups_present_flag[ tileID ][ patchIdx ] ){ | |
| pdu_feature_goups_count_minus1[ tileID ][ patchIdx ] | ue(v) |
| for( i=0; i< pdu_feature_goups_count_minus1 [ tileID ][ patchIdx ] +1;i | |
| ++ ){ | |
| pdu_feature_group(tileID, patchIdx, i ) | |
| } | |
| } | |
| pdu_parameters_override_flag[ tileID ][ patchIdx ] | u(1) |
| if( pdu_parameters_override_flag[ tileID ][ patchIdx ] ){ | |
| pdu_subdivision_override_flag[ tileID ][ patchIdx ] | u(1) |
| pdu_transform_method_override_flag[ tileID ][ patchIdx ] | u(1) |
| pdu_transform_parameters_override_flag[ tileID ][ patchIdx ] | u(1) |
| } | |
| if( pdu_subdivision_override_flag[ tileID ][ patchIdx ] ){ | |
| pdu_subdivision_method[ tileID ][ patchIdx ] | u(3) |
| if( pdu_subdivision_method[ tileID ][ patchIdx ] != 0 ){ | |
| pdu_subdivision_iteration_count[ tileID ][ patchIdx ] | u(8) |
| patchSubdivisionCount = pdu_subdivision_iteration_count[ tileID ][ pa | |
| tchIdx ] | |
| } else { | |
| patchSubdivisionCount = 0 | |
| } | |
| } else { | |
| patchSubdivisionCount = AfpsSubdivisonCount | |
| } | |
| pdu_displacement_coordinate_system[ tileID ][ patchIdx ] | u(1) |
| if(pdu_transform_method_override_flag[ tileID ][ patchIdx ]) | |
| pdu_transform_method[ tileID ][ patchIdx ] | u(3) |
| if(pdu_transform_method[ tileID ][ patchIdx ]== LINEAR_LIFTING | |
| && | |
| pdu_transform_parameters_override_flag[ tileID ][ patchIdx ]) { | |
| vdmc_lifting_transform_parameters(2, patchSubdivisionCount ) | |
| } | |
| for( i=0; i< asve_num_attribute_video; i++ ){ | |
| if( asve_attribute_subtexture_enabled_flag[ i ] ){ | |
| pdu_attributes_2d_pos_x[ tileID ][ patchIdx ][ i ] | ue(v) |
| pdu_attributes_2d_pos_y[ tileID ][ patchIdx ][ i ] | ue(v) |
| pdu_attributes_2d_size_x_minus1[ tileID ][ patchIdx ][ i ] | ue(v) |
| pdu_attributes_2d_size_y_minus1[ tileID ][ patchIdx ][ i ] | ue(v) |
| } | |
| } | |
| if( afve_projection_texcoord_present_flag[ smIdx ] ) | |
| texture_projection_information( tileID, patchIdx ) | |
| } | |

pdu_feature_groups_present_flag[tileID][patchIdx] equal to 1 indicates that feature groups are present in the submesh with submesh ID equal to pdu_submesh_id [tileID][patchIdx] and that the syntax element pdu_feature_goups_count_minus1[tileID][patchIdx] is present for patch patchIdx in the current atlas tile, with tile ID equal to tileID.

pdu_feature_goups_count_minus1[tileID][patchIdx] pluse one indicates the number of feature groups present in the submesh with submesh ID equal to pdu_submesh_id [tileID][patchIdx] and number of syntax structures pdu_feature_group(tileID, patchIdx, i) present for patch patchIdx in the current atlas tile, with tile ID equal to tileID.

pdu_feature_group(tileID, patchIdx, i) provides the information and subdivision iteration count parameters for the feature group with index i in the submesh with submesh ID equal to pdu_submesh_id [tileID][patchIdx]

The pdu_feature_group(tileID, patchIdx, pdufgIdx) is detailed below.

| | Descriptor |
|---|---|
| pdu_feature_group(tileID, patchIdx, pdufgIdx){ | |
| pdufg_feature_count_minus1[ tileID ][ patchIdx ] [ pdufgIdx ] | ue(v) |
| for (i = 0; i < pdufg_point_count_minus1[ tileID ][ patchIdx ] [ | |
| pdufgIdx ]; i++ ) { | |
| pdufg_vertex_index[ tileID ][ patchIdx ] [ pdufgIdx ] [ i ] | ue(v) |
| } | |
| pdufg_subdivision_itration_count[ tileID ][ patchIdx ] [ pdufgIdx ] | ue(v) |
| pdufg_projection_enabled_flag[ tileID ][ patchIdx ] [ pdufgIdx ] | u(1) |
| if(pdufg_projection_enabled_flag[ tilelD ][ patchIdx ] [ pdufgIdx ]) | |
| pdufg_projection_method[ tileID ][ patchIdx ] [ pdufgIdx ] | u(2) |

pdufg_feature_count_minus1[tileID][patchIdx][pdufgIdx] indicates the number of feature points in the feature group with index pdufgIdx in submesh with submesh ID equal to pdu_submesh_id [tileID][patchIdx] for tile tileID and patch patchIdx.

pdufg_vertex_index[tileID][patchIdx][pdufgIdx][i] indicates the vertex index for the ith point in the feature group with index pdufgIdx in the submesh with submesh ID equal pdu_submesh_id [tileID][patchIdx] for tile tileID and patch patchIdx

pdufg_subdivision_itration_count[tileID][patchIdx][pdufgIdx] indicates the subdivision iteration count for all edges containing the points included in the feature group index pdufgIdx in the submesh pdu_submesh_id [tileID][patchIdx] for tile tileID and patch patchIdx

In one embodiment the pdufg_subdivision_itration_count may be signaled as delta to pdu_subdivision_iteration_count[tileID][patchIdx] to reduce the amount of bits needed to store the value.

pdufg_projection_enabled_flag[tileID][patchIdx][pdufgIdx] equal to 1 indicates that projection method is enabled to map feature points included in the feature group index pdufgIdx in the submesh pdu_submesh_id [tileID][patchIdx] for tile tileID and patch patchIdx onto the submesh base mesh vertices, edges or triangles.

In one embodiment pdufg_projection_enabled_flag[tileID][patchIdx][pdufgIdx] is not present and pdufg_projection_method[tileID][patchIdx][pdufgIdx] is always present

pdufg_projection_method[tileID][patchIdx][pdufgIdx] indicates the projection method used for the feature group index pdufgIdx in the submesh pdu_submesh_id [tileID][patchIdx] for tile tileID and patch patchIdx as in the following table

pdufg_projection_method(tileID, patchIdx, pdufgIdx) is provided below and covers the case where the feature points are not vertices that are connected to the surface of the base mesh.

| pdufg_projection_method(tileID, | |
|---|---|
| patchIdx, pdufgIdx) value | method |
| 0 | NONE |
| 1 | CLOSEST_VERTEX |
| 2 | NORMAL_PROJECTION |
| 3 | RESERVED |

NONE: no projection is used to map a feature point to the submesh base mesh

CLOSEST_VERTEX: the feature point is mapped to the closest vertex of the base mesh

NORMAL_PROJECTION: the feature point is projected following its normal direction on the base mesh

RESERVED: reserved for future additional methods

Not all cases have been detailed by the signaling embodiments described previously. For example, not all feature primitive cases for the signaling have been described previously. However, signaling related to other primitives (for example, other than a vertex) may also be implemented or used, based on the examples described herein.

### 4. Displacement Packing, Coding Decoding

The feature adaptive subdivision provides the functionality of adding details closer to feature points and feature lines instead of a full submesh region that requires to be zippered with neighboring submeshes.

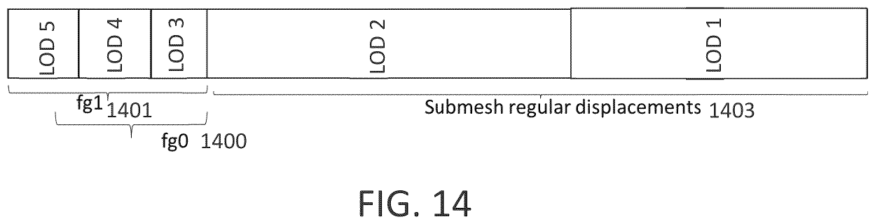

Signaled values of number of displacements per LOD take into account the displacements that are specific to feature points or lines. It follows that displacements for larger LODs that are only defined for feature points or lines contain a smaller number of values than what a regular subdivision-based LOD would contain. FIG. 14 illustrates this concept for two feature groups fg0 1400 (subdivision iteration count 4) and fg1 1401 (subdivision iteration count 5). Accordingly, FIG. 14 shows displacement sorted by LOD level for feature groups fg0 1400 and fg1 1401 with 4 and 5 subdivision iteration counts respectively, while the mesh patch iteration count is set to 2, the relative size of displacements for LODs 3, 4 and 5 that are specific to the feature-adaptive subdivision is significantly reduced.

As shown in FIG. 14, fg1 1401 includes LOD 5, LOD 4, and LOD 3, and fg0 includes LOD4 and LOD 3. FIG. 14 further shows submesh regular displacements 1403 including LOD 2 and LOD 1.

The decoder decodes the displacement frame after extracting and parsing the displacement data unit:

ddu_lod_count[displID] indicates the number of the subdivision levels(?) used for the displacement signaled in the data unit associated with displId displID

ddu_vertex_lod_count[displID]][i] indicates the number of displacements for the i-th level of wavelet transform for the data unit associated with displId displID.

In one embodiment, packing for feature groups specific LODs may be put in separate rectangular video tiles that can be decoded separately. This enables for example to separate the process for regular subdivisions and feature group subdivisions. A flag may be signaled in or along the bitstream to indicate that feature point related displacements are packed into specific regions.

### 5. Decoding Process

The decoding process is as follows (1-11):
1. Receive a bitstream that contains a frame of an encoded mesh sequence
2. Decode submesh base mesh substreams
3. Extract and decode the metadata substream for each submesh
4. For each submesh, identify if feature adaptive subdivision is enabled
5. If so identify the number of feature groups and their subdivision iteration count
6. Identify the subdivision iteration count of the submesh
7. Identify the number of LoDs and their number of vertices in the metadata
8. Decode displacements for each LOD
9. Perform feature-adaptive subdivision and apply decoded displacements
10. Reconstruct the mesh frame
11. Optional: Identify if a projection is needed and if so the projection technique to be used for feature points decoded in the base mesh

The examples described herein may be adopted with the V-DMC standard

Throughout this description ISO/IEC 23090-29 means the output document MDS23318_WG07_N00744 of MPEG144.

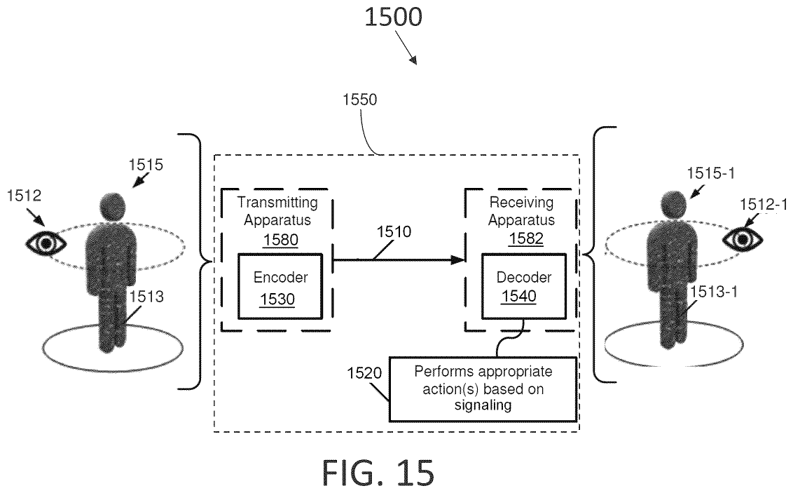

FIG. 15 is a block diagram illustrating a system 1500 in accordance with an example. In the example, the encoder 1530 is used to encode video from the scene 1515, and the encoder 1530 is implemented in a transmitting apparatus 1580. The encoder 1530 produces a bitstream 1510 comprising signaling that is received by the receiving apparatus 1582, which implements a decoder 1540. The encoder 1530 sends the bitstream 1510 that comprises the herein described signaling. The decoder 1540 forms the video for the scene 1515-1, and the receiving apparatus 1582 would present this to the user, e.g., via a smartphone, television, or projector among many other options.

In some examples, the transmitting apparatus 1580 and the receiving apparatus 1582 are at least partially within a common apparatus, and for example are located within a common housing 1550. In other examples the transmitting apparatus 1580 and the receiving apparatus 1582 are at least partially not within a common apparatus and have at least partially different housings. Therefore in some examples, the encoder 1530 and the decoder 1540 are at least partially within a common apparatus, and for example are located within a common housing 1550. For example the common apparatus comprising the encoder 1530 and decoder 1540 implements a codec. In other examples the encoder 1530 and the decoder 1540 are at least partially not within a common apparatus and have at least partially different housings, but when together still implement a codec.

3D media from the capture (e.g., volumetric capture) at a viewpoint 1512 of the scene 1515, which includes a person 1513) is converted via projection to a series of 2D representations with occupancy, geometry, and attributes. Additional atlas information is also included in the bitstream to enable inverse reconstruction. For decoding, the received bitstream 1510 is separated into its components with atlas information; occupancy, geometry, and attribute 2D representations. A 3D reconstruction is performed to reconstruct the scene 1515-1 created looking at the viewpoint 1512-1 with a “reconstructed” person 1513-1. The “−1” are used to indicate that these are reconstructions of the original. As indicated at 1520, the decoder 1540 performs an action or actions based on the received signaling.

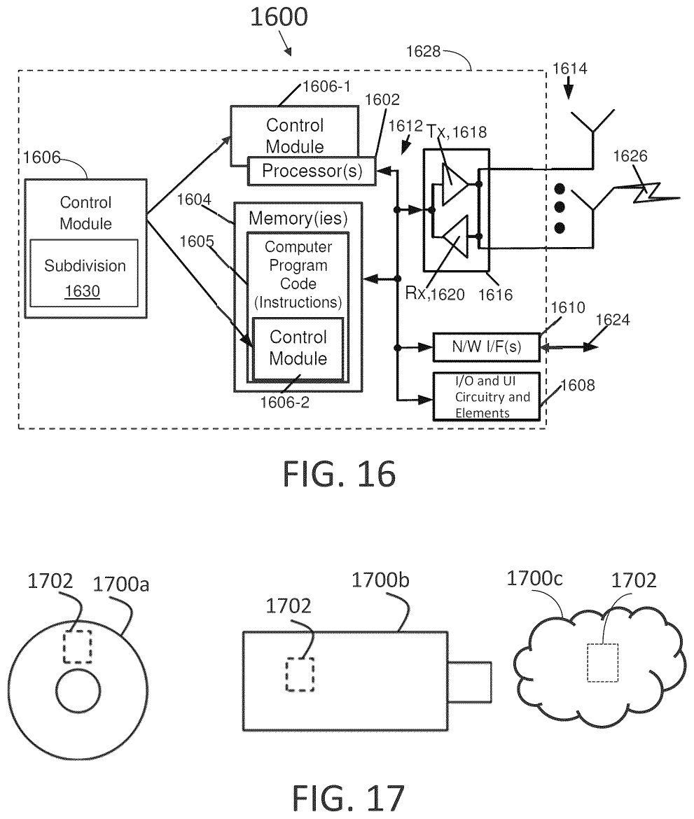

FIG. 16 is an example apparatus 1600, which may be implemented in hardware, configured to implement the examples described herein. The apparatus 1600 comprises at least one processor 1602 (e.g., an FPGA and/or CPU), one or more memories 1604 including computer program code 1605, the computer program code 1605 having instructions to carry out the methods described herein, wherein the at least one memory 1604 and the computer program code 1605 are configured to, with the at least one processor 1602, cause the apparatus 1600 to implement circuitry, a process, component, module, or function (implemented with control module 1606) to implement the examples described herein, including encapsulating and streaming attenuation maps for green metadata. Subdivision 1630 of the control module 1606 implements the embodiments described herein related to feature adaptive V-DMC subdivisions and tessellations, including transmitting and/or receiving signaling related to subdivisions. The memory 1604 may be a non-transitory memory, a transitory memory, a volatile memory (e.g. RAM), or a non-volatile memory (e.g., ROM).

The apparatus 1600 includes a display and/or I/O interface 1608, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1600 includes one or more communication e.g. network (N/W) interfaces (I/F(s)) 1610. The communication I/F(s) 1610 may be wired and/or wireless and communicate over the Internet/other network(s) via any communication technique including via one or more links 1624. The communication I/F(s) 1610 may comprise one or more transmitters or one or more receivers.

The transceiver 1616 comprises one or more transmitters 1618 and one or more receivers 1620. The transceiver 1616 and/or communication I/F(s) 1610 may comprise standard well-known components such as an amplifier, filter, frequency-converter, (de)modulator, and encoder/decoder circuitries and one or more antennas, such as antennas 1614 used for communication over wireless link 1626.

The control module 1606 of the apparatus 1600 comprises one of or both parts 1606-1 and/or 1606-2, which may be implemented in a number of ways. The control module 1606 may be implemented in hardware as control module 1606-1, such as being implemented as part of the one or more processors 1602. The control module 1606-1 may be implemented also as an integrated circuit or through other hardware such as a programmable gate array. In another example, the control module 1606 may be implemented as control module 1606-2, which is implemented as computer program code (having corresponding instructions) 1605 and is executed by the one or more processors 1602. For instance, the one or more memories 1604 store instructions that, when executed by the one or more processors 1602, cause the apparatus 1600 to perform one or more of the operations as described herein. Furthermore, the one or more processors 1602, one or more memories 1604, and example algorithms (e.g., as flowcharts and/or signaling diagrams), encoded as instructions, programs, or code, are means for causing performance of the operations described herein.

The apparatus 1600 to implement the functionality of control 1606 may correspond to any of the apparatuses depicted herein. Alternatively, apparatus 1600 and its elements may not correspond to any of the other apparatuses depicted herein, as apparatus 1600 may be part of a self-organizing/optimizing network (SON) node or other node, such as a node in a cloud.

The apparatus 1600 may also be distributed throughout the network including within and between apparatus 1600 and any network element (such as a base station and/or terminal device and/or user equipment).

Interface 1612 enables data communication and signaling between the various items of apparatus 1600, as shown in FIG. 16. For example, the interface 1612 may be one or more buses such as address, data, or control buses, and may include any interconnection mechanism, such as a series of lines on a motherboard or integrated circuit, fiber optics or other optical communication equipment, and the like. Computer program code (e.g. instructions) 1605, including control 1606 may comprise object-oriented software configured to pass data or messages between objects within computer program code 1605. The apparatus 1600 need not comprise each of the features mentioned, or may comprise other features as well. The various components of apparatus 1600 may at least partially reside in a common housing 1628, or a subset of the various components of apparatus 1600 may at least partially be located in different housings, which different housings may include housing 1628.

FIG. 17 shows a schematic representation of non-volatile memory media 1700a (e.g. computer/compact disc (CD) or digital versatile disc (DVD)) and 1700b (e.g. universal serial bus (USB) memory stick) and 1700c (e.g. cloud storage for downloading instructions and/or parameters 1702 or receiving emailed instructions and/or parameters 1702) storing instructions and/or parameters 1702 which when executed by a processor allows the processor to perform one or more of the operations of the methods described herein. Instructions and/or parameters 1702 may represent or correspond to a non-transitory computer readable medium.

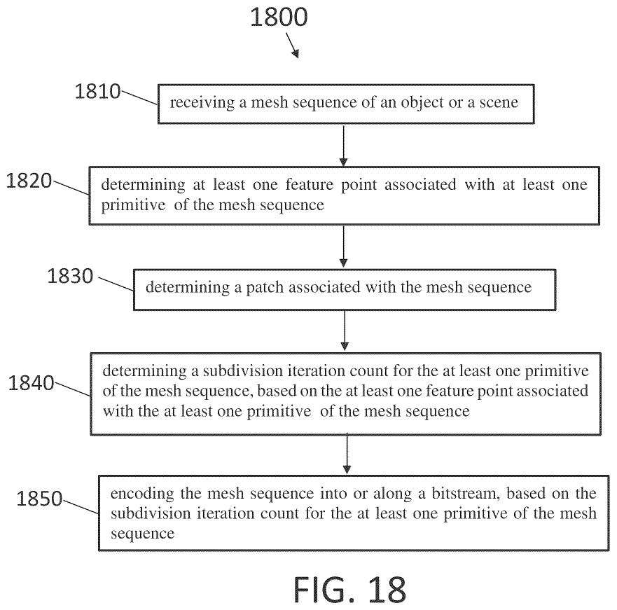

FIG. 18 is an example method 1800, based on the example embodiments described herein. At 1810, the method includes receiving a mesh sequence of an object or a scene. At 1820, the method includes determining at least one feature point associated with at least one primitive of the mesh sequence. At 1830, the method includes determining a patch associated with the mesh sequence. At 1840, the method includes determining a subdivision iteration count for the at least one primitive of the mesh sequence, based on the at least one feature point associated with the at least one primitive of the mesh sequence. At 1840, the method includes encoding the mesh sequence into or along a bitstream, based on the subdivision iteration count for the at least one primitive of the mesh sequence. Method 1800 may be performed with encoder 100, transmitting apparatus 1580 with encoder 1530, or apparatus 1600.

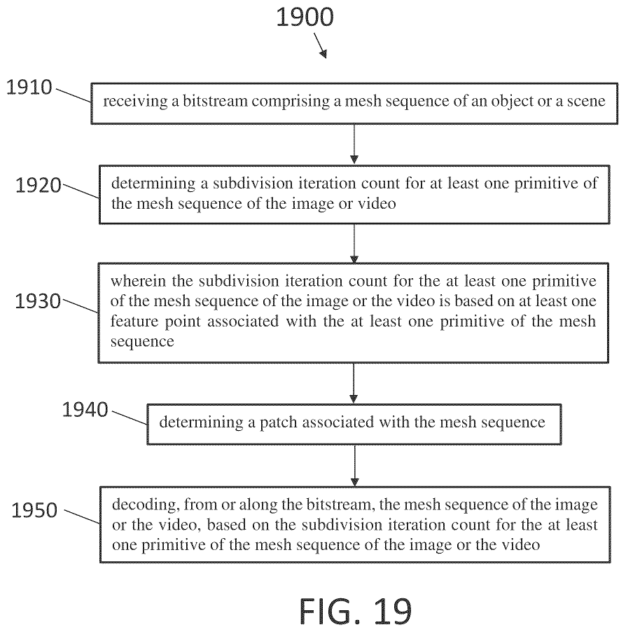

FIG. 19 is an example method 1900, based on the example embodiments described herein. At 1910, the method includes receiving a bitstream comprising a mesh sequence of an object or a scene. At 1920, the method includes determining a subdivision iteration count for at least one primitive of the mesh sequence of the image or video. At 1930, the method includes wherein the subdivision iteration count for the at least one primitive of the mesh sequence of the image or the video is based on at least one feature point associated with the at least one primitive of the mesh sequence. At 1940, the method includes determining a patch associated with the mesh sequence. At 1950, the method includes decoding, from or along the bitstream, the mesh sequence of the image or the video, based on the subdivision iteration count for the at least one primitive of the mesh sequence of the image or the video. Method 1900 may be performed with decoder 200, receiving apparatus 1582 with decoder 1540, or apparatus 1600.

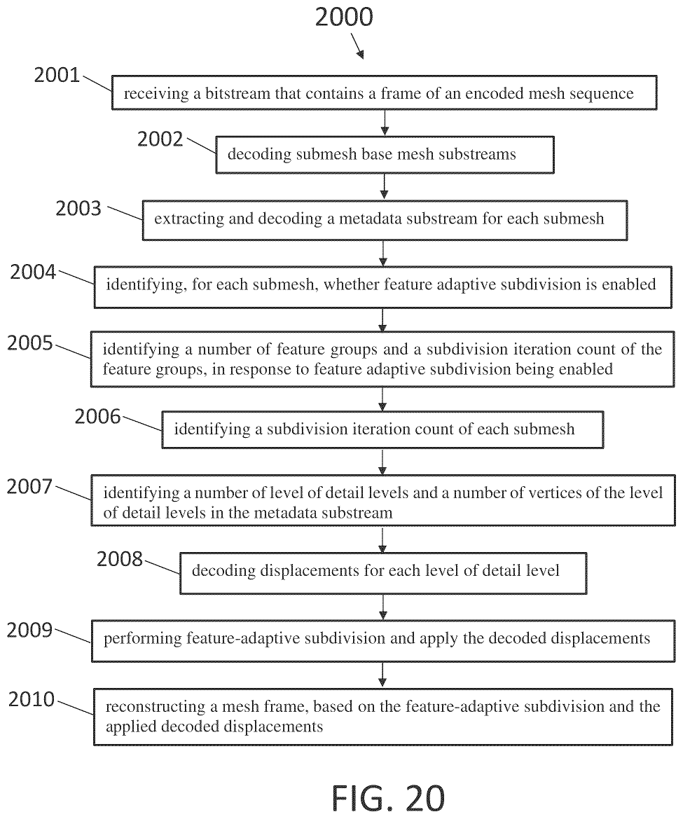

FIG. 20 is an example method 2000, based on the example embodiments described herein. At 2001, the method includes receiving a bitstream that contains a frame of an encoded mesh sequence. At 2002, the method includes decoding submesh base mesh substreams. At 2003, the method includes extracting and decoding a metadata substream for each submesh. At 2004, the method includes identifying, for each submesh, whether feature adaptive subdivision is enabled. At 2005, the method includes identifying a number of feature groups and a subdivision iteration count of the feature groups, in response to feature adaptive subdivision being enabled. At 2006, the method includes identifying a subdivision iteration count of each submesh. At 2007, the method includes identifying a number of level of detail levels and a number of vertices of the level of detail levels in the metadata substream. At 2008, the method includes decoding displacements for each level of detail level. At 2009, the method includes performing feature-adaptive subdivision and apply the decoded displacements. At 2010, the method includes reconstructing a mesh frame, based on the feature-adaptive subdivision and the applied decoded displacements. Method 2000 may be performed with decoder 200, receiving apparatus 1582 with decoder 1540, or apparatus 1600.

The following examples are provided and described herein.

Example 1. An apparatus including: at least one processor; and at least one memory storing instructions that, when executed by the at least one processor, cause the apparatus at least to: receive a mesh sequence of an object or a scene; determine at least one feature point associated with at least one primitive of the mesh sequence; determine a patch associated with the mesh sequence; determine a subdivision iteration count for the at least one primitive of the mesh sequence, based on the at least one feature point associated with the at least one primitive of the mesh sequence; and encode the mesh sequence into or along a bitstream, based on the subdivision iteration count for the at least one primitive of the mesh sequence.

Example 2. The apparatus of example 1, wherein the instructions, when executed by the at least one processor, cause the apparatus at least to: determine whether the at least one primitive is connected to the at least one feature point; determine at least one subdivision iteration count of the respective at least one feature point; determine a subdivision iteration count of the patch associated with the mesh sequence; determine the subdivision iteration count for the at least one primitive of the mesh sequence to be a larger of: the at least one subdivision iteration count of the respective at least one feature point, and the subdivision iteration count of the patch associated with the mesh sequence.

Example 3. The apparatus of any of examples 1 to 2, wherein the instructions, when executed by the at least one processor, cause the apparatus at least to: determine a first subdivision iteration count of a first triangle and a second subdivision iteration count of a second triangle that shares an edge with the first triangle; determine an absolute value of a difference between the first subdivision iteration count of the first triangle having the edge and the second subdivision iteration count of the second triangle having the edge; determine, from among the first triangle and the second triangle, a triangle having a smaller of the first subdivision iteration count and the second subdivision iteration count; and process the triangle having the smaller of the first subdivision iteration count and the second subdivision iteration count as a transition triangle, in response to the absolute value of the difference between the first subdivision iteration count of the first triangle having the edge and the second subdivision iteration count of the second triangle having the edge being one.

Example 4. The apparatus of any of examples 1 to 3, wherein the instructions, when executed by the at least one processor, cause the apparatus at least to: determine a first subdivision iteration count of an edge of at least one triangle, wherein the edge begins with a first vertex and ends with a second vertex; determine a second subdivision iteration count of the edge of the at least one triangle, wherein the edge begins with the second vertex and ends with the first vertex; wherein the first subdivision iteration count and the second subdivision iteration count are the same or different.

Example 5. The apparatus of any of examples 1 to 4, wherein the instructions, when executed by the at least one processor, cause the apparatus at least to: determine whether an edge of at least one triangle given with a first vertex and a second vertex contains the at least one feature point at the first vertex or the second vertex, or between the first vertex and the second vertex; determine at least one subdivision iteration count of the respective at least one feature point; determine a subdivision iteration count of the patch associated with the mesh sequence; determine a subdivision iteration count for the edge of the at least one triangle given with the first vertex and the second vertex to be a larger of the at least one subdivision iteration count of the respective at least one feature point, and the subdivision iteration count of the patch associated with the mesh sequence, in response to the edge of the at least one triangle given with the first vertex and the second vertex containing the at least one feature point at the first vertex or the second vertex, or the at least one feature point being between the first vertex and the second vertex.

Example 6. The apparatus of any of examples 1 to 5, wherein the instructions, when executed by the at least one processor, cause the apparatus at least to: determine the subdivision iteration count for the at least one primitive for faces that are not connected to an edge with an edge subdivision iteration count different from a subdivision iteration count of the patch associated with the mesh sequence to be the subdivision iteration count of the patch associated with the mesh sequence.

Example 7. The apparatus of any of examples 1 to 6, wherein the instructions, when executed by the at least one processor, cause the apparatus at least to: determine at least one edge subdivision iteration count of at least one edge of a triangle of the mesh sequence; determine a subdivision iteration count for the triangle of the mesh sequence to be a subdivision iteration count of the patch associated with the mesh sequence, in response to the at least one edge subdivision iteration count of one or two edges of the triangle, and not more than two edges of the triangle, being different from the subdivision iteration count of the patch associated with the mesh sequence; and determine the subdivision iteration count for the triangle of the mesh sequence to be a smaller of the respective at least one edge subdivision iteration count of three edges of the triangle, in response to the respective at least one edge subdivision iteration count of the three edges of the triangle being different from the subdivision iteration count of the patch associated with the mesh sequence.

Example 8. The apparatus of any of examples 1 to 7, wherein the instructions, when executed by the at least one processor, cause the apparatus at least to: determine at least one edge subdivision iteration count of at least one edge of a triangle of the mesh sequence; and process a triangle of the mesh sequence as a transition triangle, in response to a subdivision iteration count of the triangle being different from the at least one edge subdivision iteration count of the at least one edge of the triangle of the mesh sequence.

Example 9. The apparatus of any of examples 1 to 8, wherein the instructions, when executed by the at least one processor, cause the apparatus at least to: determine an edge of at least one triangle given with a first vertex and a second vertex; determine a midpoint of the edge given with the first vertex and the second vertex; determine whether a feature point of the edge is closer to the first vertex, the second vertex, or is at a midpoint of the edge between the first vertex and the second vertex; and determine whether to create another vertex or add another edge, based on whether the feature point of the edge is closer to the first vertex, the second vertex, or is at a midpoint of the edge between the first vertex and the second vertex.

Example 10. The apparatus of example 9, wherein the instructions, when executed by the at least one processor, cause the apparatus at least to: create a third vertex at a midpoint of an edge given with the second vertex and a fourth vertex, creating an edge given with the midpoint of the edge given with the first vertex and the second vertex and the third vertex, in response to the feature point being closer to the second vertex; create a fifth vertex at a midpoint of an edge given with the second vertex and a sixth vertex, creating an edge given with the midpoint of the edge given with the first vertex and the second vertex and the fifth vertex, in response to the feature point being closer to the second vertex; add an edge given with the midpoint of the edge given with the first vertex and the second vertex and the fourth vertex, due to a triangle given with the first vertex, the second vertex, and the fourth vertex being a transition triangle; and add an edge given with the midpoint of the edge given with the first vertex and the second vertex and the sixth vertex, due to a triangle given with the first vertex, the second vertex, and the sixth vertex being a transition triangle.

Example 11. The apparatus of any of examples 9 to 10, wherein the instructions, when executed by the at least one processor, cause the apparatus at least to: create a third vertex at a midpoint of an edge given with the first vertex and a fourth vertex, creating an edge given with the midpoint of the edge given with the first vertex and the second vertex and the third vertex, and create a fifth vertex at a midpoint of an edge given with the second vertex and the fourth vertex, creating an edge given with the midpoint of the edge given with the first vertex and the second vertex and the fifth vertex, and an creating edge between the third vertex and the fifth vertex, in response to the feature point being at the midpoint of the edge given with the first vertex and the second vertex; and create a sixth vertex at a midpoint of an edge given with the first vertex and a seventh vertex, creating an edge given with the midpoint of the edge given with the first vertex and the second vertex and the sixth vertex, and create an eighth vertex at a midpoint of an edge given with the second vertex and the seventh vertex, creating an edge given with the midpoint of the edge given with the first vertex and the second vertex and the eighth vertex, and creating an edge between the sixth vertex and the eight vertex, in response to the feature point being at the midpoint of the edge given with the first vertex and the second vertex.

Example 12. The apparatus of any of examples 9 to 11, wherein the instructions, when executed by the at least one processor, cause the apparatus at least to: create a third vertex at a midpoint of an edge given with the first vertex and a fourth vertex, creating an edge given with the midpoint of the edge given with the first vertex and the second vertex and the third vertex, in response to the feature point being closer to the first vertex; create a fifth vertex at a midpoint of an edge given with the first vertex and a sixth vertex, creating an edge given with the midpoint of the edge given with the first vertex and the second vertex and the fifth vertex, in response to the feature point being closer to the first vertex; add an edge given with the midpoint of the edge given with the first vertex and the second vertex and the fourth vertex, due to a triangle given with the first vertex, the second vertex, and the fourth vertex being a transition triangle; and add an edge given with the midpoint of the edge given with the first vertex and the second vertex and the sixth vertex, due to a triangle given with the first vertex, the second vertex, and the sixth vertex being a transition triangle.

Example 13. The apparatus of any of examples 1 to 12, wherein the instructions, when executed by the at least one processor, cause the apparatus at least to: determine a first subdivision iteration count of a first edge of a triangle of the mesh sequence; determine a second subdivision iteration count of a second edge of the triangle of the mesh sequence; determine a difference between the first subdivision iteration count of the first edge of the triangle of the mesh sequence, and the second subdivision iteration count of the second edge of the triangle of the mesh sequence; repeat a feature adaptive process iteratively following triangle feature adaptive subdivision, or edge feature adaptive subdivision, or vertex feature adaptive subdivision until a largest subdivision iteration count is met, in response to the difference between the first subdivision iteration count of the first edge of the triangle of the mesh sequence, and the second subdivision iteration count of the second edge of the triangle of the mesh sequence being larger than one.

Example 14. The apparatus of any of examples 1 to 13, wherein the instructions, when executed by the at least one processor, cause the apparatus at least to: assign a subdivision iteration count for the at least one primitive of the mesh sequence, and a subdivision iteration count for the at least one feature point.

Example 15. The apparatus of example 14, wherein the instructions, when executed by the at least one processor, cause the apparatus at least to determine, based on the subdivision iteration count for the at least one primitive of the mesh sequence, and the subdivision iteration count for the at least one feature point: a vertex associated with a first level of detail, whether to add a vertex associated with a second level of detail with displacement, whether to add a vertex associated with a third level of detail with displacement, whether to add an edge per level of detail, and whether to add an edge for an inter level of detail transition.

Example 16. The apparatus of any of examples 14 to 15, wherein: the subdivision iteration count for the at least one primitive of the mesh sequence is assigned to be zero, and the subdivision iteration count for the at least one feature point is assigned to be two, or the subdivision iteration count for the at least one primitive of the mesh sequence is assigned to be one, and the subdivision iteration count for the at least one feature point is assigned to be two.

Example 17. The apparatus of any of examples 1 to 16, wherein the instructions, when executed by the at least one processor, cause the apparatus at least to: determine to add at least one vertex for a subdivision, in response to several feature points sharing a base mesh primitive.

Example 18. The apparatus of any of examples 1 to 17, wherein the instructions, when executed by the at least one processor, cause the apparatus at least to: determine a type of a first feature point of the mesh sequence; determine a type of a second feature point of the mesh sequence; determine whether the first feature point and the second feature point share a base mesh primitive; and apply subdivision per the first feature point based on the type of the first feature point, and per the second feature point based on the type of the second feature point, in response to the first feature point and the second feature point not sharing a base mesh primitive.

Example 19. The apparatus of any of examples 1 to 18, wherein the instructions, when executed by the at least one processor, cause the apparatus at least to: predict a level of detail from a first level to a second level, based on subdivision iteration count for the at least one primitive of the mesh sequence.

Example 20. The apparatus of any of examples 1 to 19, wherein the instructions, when executed by the at least one processor, cause the apparatus at least to: signal the subdivision iteration count for the at least one primitive of the mesh sequence within a patch data unit syntax element.

Example 21. The apparatus of any of examples 1 to 20, wherein the instructions, when executed by the at least one processor, cause the apparatus at least to: determine a subdivision iteration count of a feature group comprising two or more level of detail levels.

Example 22. The apparatus of any of examples 1 to 21, wherein the at least one primitive comprises: a vertex, or an edge, or a triangle, or a face, or a face of a triangle, or a face of a polygon having more than three vertices and more than three edges.

Example 23. An apparatus including: at least one processor; and at least one memory storing instructions that, when executed by the at least one processor, cause the apparatus at least to: receive a bitstream comprising a mesh sequence of an object or a scene; determine a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; determine a patch associated with the mesh sequence; and decode, from or along the bitstream, the mesh sequence of the image or the video, based on the subdivision iteration count for the at least one primitive of the mesh sequence of the image or the video.

Example 24. The apparatus of example 23, wherein the instructions, when executed by the at least one processor, cause the apparatus at least to: determine whether the at least one primitive is connected to the at least one feature point; determine at least one subdivision iteration count of the respective at least one feature point; determine a subdivision iteration count of the patch associated with the mesh sequence; determine the subdivision iteration count for the at least one primitive of the mesh sequence to be a larger of: the at least one subdivision iteration count of the respective at least one feature point, and the subdivision iteration count of the patch associated with the mesh sequence.

Example 25. The apparatus of any of examples 23 to 24, wherein the instructions, when executed by the at least one processor, cause the apparatus at least to: determine a first subdivision iteration count of a first triangle and a second subdivision iteration count of a second triangle that shares an edge with the first triangle; determine an absolute value of a difference between the first subdivision iteration count of the first triangle having the edge and the second subdivision iteration count of the second triangle having the edge; determine, from among the first triangle and the second triangle, a triangle having a smaller of the first subdivision iteration count and the second subdivision iteration count; and process the triangle having the smaller of the first subdivision iteration count and the second subdivision iteration count as a transition triangle, in response to the absolute value of the difference between the first subdivision iteration count of the first triangle having the edge and the second subdivision iteration count of the second triangle having the edge being one.

Example 26. The apparatus of any of examples 23 to 25, wherein the instructions, when executed by the at least one processor, cause the apparatus at least to: determine a first subdivision iteration count of an edge of at least one triangle, wherein the edge begins with a first vertex and ends with a second vertex; determine a second subdivision iteration count of the edge of the at least one triangle, wherein the edge begins with the second vertex and ends with the first vertex; wherein the first subdivision iteration count and the second subdivision iteration count are the same or different.

Example 27. The apparatus of any of examples 23 to 26, wherein the instructions, when executed by the at least one processor, cause the apparatus at least to: determine whether an edge of at least one triangle given with a first vertex and a second vertex contains the at least one feature point at the first vertex or the second vertex, or between the first vertex and the second vertex; determine at least one subdivision iteration count of the respective at least one feature point; determine a subdivision iteration count of the patch associated with the mesh sequence; determine a subdivision iteration count for the edge of the at least one triangle given with the first vertex and the second vertex to be a larger of the at least one subdivision iteration count of the respective at least one feature point, and the subdivision iteration count of the patch associated with the mesh sequence, in response to the edge of the at least one triangle given with the first vertex and the second vertex containing the at least one feature point at the first vertex or the second vertex, or the at least one feature point being between the first vertex and the second vertex.

Example 28. The apparatus of any of examples 23 to 27, wherein the instructions, when executed by the at least one processor, cause the apparatus at least to: determine the subdivision iteration count for the at least one primitive for faces that are not connected to an edge with an edge subdivision iteration count different from a subdivision iteration count of the patch associated with the mesh sequence to be the subdivision iteration count of the patch associated with the mesh sequence.

Example 29. The apparatus of any of examples 23 to 28, wherein the instructions, when executed by the at least one processor, cause the apparatus at least to: determine at least one edge subdivision iteration count of at least one edge of a triangle of the mesh sequence; determine a subdivision iteration count for the triangle of the mesh sequence to be a subdivision iteration count of the patch associated with the mesh sequence, in response to the at least one edge subdivision iteration count of one or two edges of the triangle, and not more than two edges of the triangle, being different from the subdivision iteration count of the patch associated with the mesh sequence; and determine the subdivision iteration count for the triangle of the mesh sequence to be a smaller of the respective at least one edge subdivision iteration count of three edges of the triangle, in response to the respective at least one edge subdivision iteration count of the three edges of the triangle being different from the subdivision iteration count of the patch associated with the mesh sequence.

Example 30. The apparatus of any of examples 23 to 29, wherein the instructions, when executed by the at least one processor, cause the apparatus at least to: determine at least one edge subdivision iteration count of at least one edge of a triangle of the mesh sequence; and process a triangle of the mesh sequence as a transition triangle, in response to a subdivision iteration count of the triangle being different from the at least one edge subdivision iteration count of the at least one edge of the triangle of the mesh sequence.

Example 31. The apparatus of any of examples 23 to 30, wherein the instructions, when executed by the at least one processor, cause the apparatus at least to: determine an edge of at least one triangle given with a first vertex and a second vertex; determine a midpoint of the edge given with the first vertex and the second vertex; determine whether a feature point of the edge is closer to the first vertex, the second vertex, or is at a midpoint of the edge between the first vertex and the second vertex; and determine whether to create another vertex or add another edge, based on whether the feature point of the edge is closer to the first vertex, the second vertex, or is at a midpoint of the edge between the first vertex and the second vertex.

Example 32. The apparatus of example 31, wherein the instructions, when executed by the at least one processor, cause the apparatus at least to: create a third vertex at a midpoint of an edge given with the second vertex and a fourth vertex, creating an edge given with the midpoint of the edge given with the first vertex and the second vertex and the third vertex, in response to the feature point being closer to the second vertex; create a fifth vertex at a midpoint of an edge given with the second vertex and a sixth vertex, creating an edge given with the midpoint of the edge given with the first vertex and the second vertex and the fifth vertex, in response to the feature point being closer to the second vertex; add an edge given with the midpoint of the edge given with the first vertex and the second vertex and the fourth vertex, due to a triangle given with the first vertex, the second vertex, and the fourth vertex being a transition triangle; and add an edge given with the midpoint of the edge given with the first vertex and the second vertex and the sixth vertex, due to a triangle given with the first vertex, the second vertex, and the sixth vertex being a transition triangle.

Example 33. The apparatus of any of examples 31 to 32, wherein the instructions, when executed by the at least one processor, cause the apparatus at least to: create a third vertex at a midpoint of an edge given with the first vertex and a fourth vertex, creating an edge given with the midpoint of the edge given with the first vertex and the second vertex and the third vertex, and create a fifth vertex at a midpoint of an edge given with the second vertex and the fourth vertex, creating an edge given with the midpoint of the edge given with the first vertex and the second vertex and the fifth vertex, and creating an edge between the third vertex and the fifth vertex, in response to the feature point being at the midpoint of the edge given with the first vertex and the second vertex; and create a sixth vertex at a midpoint of an edge given with the first vertex and a seventh vertex, creating an edge given with the midpoint of the edge given with the first vertex and the second vertex and the sixth vertex, and create an eighth vertex at a midpoint of an edge given with the second vertex and the seventh vertex, creating an edge given with the midpoint of the edge given with the first vertex and the second vertex and the eighth vertex, and creating an edge between the sixth vertex and the eight vertex, in response to the feature point being at the midpoint of the edge given with the first vertex and the second vertex.

Example 34. The apparatus of any of examples 31 to 33, wherein the instructions, when executed by the at least one processor, cause the apparatus at least to: create a third vertex at a midpoint of an edge given with the first vertex and a fourth vertex, creating an edge given with the midpoint of the edge given with the first vertex and the second vertex and the third vertex, in response to the feature point being closer to the first vertex; create a fifth vertex at a midpoint of an edge given with the first vertex and a sixth vertex, creating an edge given with the midpoint of the edge given with the first vertex and the second vertex and the fifth vertex, in response to the feature point being closer to the first vertex; add an edge given with the midpoint of the edge given with the first vertex and the second vertex and the fourth vertex, due to a triangle given with the first vertex, the second vertex, and the fourth vertex being a transition triangle; and add an edge given with the midpoint of the edge given with the first vertex and the second vertex and the sixth vertex, due to a triangle given with the first vertex, the second vertex, and the sixth vertex being a transition triangle.

Example 35. The apparatus of any of examples 23 to 34, wherein the instructions, when executed by the at least one processor, cause the apparatus at least to: determine a first subdivision iteration count of a first edge of a triangle of the mesh sequence; determine a second subdivision iteration count of a second edge of the triangle of the mesh sequence; determine a difference between the first subdivision iteration count of the first edge of the triangle of the mesh sequence, and the second subdivision iteration count of the second edge of the triangle of the mesh sequence; repeat a feature adaptive process iteratively following triangle feature adaptive subdivision, or edge feature adaptive subdivision, or vertex feature adaptive subdivision until a largest subdivision iteration count is met, in response to the difference between the first subdivision iteration count of the first edge of the triangle of the mesh sequence, and the second subdivision iteration count of the second edge of the triangle of the mesh sequence being larger than one.

Example 36. The apparatus of any of examples 23 to 35, wherein the instructions, when executed by the at least one processor, cause the apparatus at least to: assign a subdivision iteration count for the at least one primitive of the mesh sequence, and a subdivision iteration count for the at least one feature point.

Example 37. The apparatus of example 36, wherein the instructions, when executed by the at least one processor, cause the apparatus at least to determine, based on the subdivision iteration count for the at least one primitive of the mesh sequence, and the subdivision iteration count for the at least one feature point: a vertex associated with a first level of detail, whether to add a vertex associated with a second level of detail with displacement, whether to add a vertex associated with a third level of detail with displacement, whether to add an edge per level of detail, and whether to add an edge for an inter level of detail transition.

Example 38. The apparatus of any of examples 36 to 37, wherein: the subdivision iteration count for the at least one primitive of the mesh sequence is assigned to be zero, and the subdivision iteration count for the at least one feature point is assigned to be two, or the subdivision iteration count for the at least one primitive of the mesh sequence is assigned to be one, and the subdivision iteration count for the at least one feature point is assigned to be two.

Example 39. The apparatus of any of examples 23 to 38, wherein the instructions, when executed by the at least one processor, cause the apparatus at least to: determine to add at least one vertex for a subdivision, in response to several feature points sharing a base mesh primitive.

Example 40. The apparatus of any of examples 23 to 39, wherein the instructions, when executed by the at least one processor, cause the apparatus at least to: determine a type of a first feature point of the mesh sequence; determine a type of a second feature point of the mesh sequence; determine whether the first feature point and the second feature point share a base mesh primitive; and apply subdivision per the first feature point based on the type of the first feature point, and per the second feature point based on the type of the second feature point, in response to the first feature point and the second feature point not sharing a base mesh primitive.

Example 41. The apparatus of any of examples 23 to 40, wherein the instructions, when executed by the at least one processor, cause the apparatus at least to: predict a level of detail from a first level to a second level, based on subdivision iteration count for the at least one primitive of the mesh sequence.

Example 42. The apparatus of any of examples 23 to 41, wherein the instructions, when executed by the at least one processor, cause the apparatus at least to: decode signaling of the subdivision iteration count for the at least one primitive of the mesh sequence within a patch data unit syntax element.

Example 43. The apparatus of any of examples 23 to 42, wherein the instructions, when executed by the at least one processor, cause the apparatus at least to: determine a subdivision iteration count of a feature group comprising two or more level of detail levels.

Example 44. The apparatus of any of examples 23 to 43, wherein the at least one primitive comprises: a vertex, or an edge, or a triangle, or a face, or a face of a triangle, or a face of a polygon having more than three vertices and more than three edges.

Example 45. The apparatus of any of examples 23 to 44, wherein the instructions, when executed by the at least one processor, cause the apparatus at least to: determine whether to use a projection; and determine a projection technique to be used for feature points decoded from the mesh sequence, in response to determining to use the projection.

Example 46. An apparatus including: at least one processor; and at least one memory storing instructions that, when executed by the at least one processor, cause the apparatus at least to: receive a bitstream that contains a frame of an encoded mesh sequence; decode submesh base mesh substreams; extract and decode a metadata substream for each submesh; identify, for each submesh, whether feature adaptive subdivision is enabled; identify a number of feature groups and a subdivision iteration count of the feature groups, in response to feature adaptive subdivision being enabled; identify a subdivision iteration count of each submesh; identify a number of level of detail levels and a number of vertices of the level of detail levels in the metadata substream; decode displacements for each level of detail level; perform feature-adaptive subdivision and apply the decoded displacements; and reconstruct a mesh frame, based on the feature-adaptive subdivision and the applied decoded displacements.

Example 47. The apparatus of example 46, wherein the instruction, when executed by the at least one processor, cause the apparatus at least to: identify whether to use a projection; and determine a projection technique to be used for feature points decoded from the encoded mesh sequence, in response to determining to use the projection.

Example 48. A method including: receiving a mesh sequence of an object or a scene; determining at least one feature point associated with at least one primitive of the mesh sequence; determining a patch associated with the mesh sequence; determining a subdivision iteration count for the at least one primitive of the mesh sequence, based on the at least one feature point associated with the at least one primitive of the mesh sequence; and encoding the mesh sequence into or along a bitstream, based on the subdivision iteration count for the at least one primitive of the mesh sequence.

Example 49. A method including: receiving a bitstream comprising a mesh sequence of an object or a scene; determining a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; determining a patch associated with the mesh sequence; and decoding, from or along the bitstream, the mesh sequence of the image or the video, based on the subdivision iteration count for the at least one primitive of the mesh sequence of the image or the video.

Example 50. A method including: receiving a bitstream that contains a frame of an encoded mesh sequence; decoding submesh base mesh substreams; extracting and decoding a metadata substream for each submesh; identifying, for each submesh, whether feature adaptive subdivision is enabled; identifying a number of feature groups and a subdivision iteration count of the feature groups, in response to feature adaptive subdivision being enabled; identifying a subdivision iteration count of each submesh; identifying a number of level of detail levels and a number of vertices of the level of detail levels in the metadata substream; decoding displacements for each level of detail level; performing feature-adaptive subdivision and apply the decoded displacements; and reconstructing a mesh frame, based on the feature-adaptive subdivision and the applied decoded displacements.

Example 51. An apparatus including: means for receiving a mesh sequence of an object or a scene; means for determining at least one feature point associated with at least one primitive of the mesh sequence; means for determining a patch associated with the mesh sequence; means for determining a subdivision iteration count for the at least one primitive of the mesh sequence, based on the at least one feature point associated with the at least one primitive of the mesh sequence; and means for encoding the mesh sequence into or along a bitstream, based on the subdivision iteration count for the at least one primitive of the mesh sequence.

Example 52. An apparatus including: means for receiving a bitstream comprising a mesh sequence of an object or a scene; means for determining a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; means for determining a patch associated with the mesh sequence; and means for decoding, from or along the bitstream, the mesh sequence of the image or the video, based on the subdivision iteration count for the at least one primitive of the mesh sequence of the image or the video.

Example 53. An apparatus including: means for receiving a bitstream that contains a frame of an encoded mesh sequence; means for decoding submesh base mesh substreams; means for extracting and decoding a metadata substream for each submesh; means for identifying, for each submesh, whether feature adaptive subdivision is enabled; means for identifying a number of feature groups and a subdivision iteration count of the feature groups, in response to feature adaptive subdivision being enabled; means for identifying a subdivision iteration count of each submesh; means for identifying a number of level of detail levels and a number of vertices of the level of detail levels in the metadata substream; means for decoding displacements for each level of detail level; means for performing feature-adaptive subdivision and apply the decoded displacements; and means for reconstructing a mesh frame, based on the feature-adaptive subdivision and the applied decoded displacements.

Example 54. A computer readable medium including instructions stored thereon for performing at least the following: receiving a mesh sequence of an object or a scene; determining at least one feature point associated with at least one primitive of the mesh sequence; determining a patch associated with the mesh sequence; determining a subdivision iteration count for the at least one primitive of the mesh sequence, based on the at least one feature point associated with the at least one primitive of the mesh sequence; and encoding the mesh sequence into or along a bitstream, based on the subdivision iteration count for the at least one primitive of the mesh sequence.

Example 55. A computer readable medium including instructions stored thereon for performing at least the following: receiving a bitstream comprising a mesh sequence of an object or a scene; determining a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; determining a patch associated with the mesh sequence; and decoding, from or along the bitstream, the mesh sequence of the image or the video, based on the subdivision iteration count for the at least one primitive of the mesh sequence of the image or the video.

Example 56. A computer readable medium including instructions stored thereon for performing at least the following: receiving a bitstream that contains a frame of an encoded mesh sequence; decoding submesh base mesh substreams; extracting and decoding a metadata substream for each submesh; identifying, for each submesh, whether feature adaptive subdivision is enabled; identifying a number of feature groups and a subdivision iteration count of the feature groups, in response to feature adaptive subdivision being enabled; identifying a subdivision iteration count of each submesh; identifying a number of level of detail levels and a number of vertices of the level of detail levels in the metadata substream; decoding displacements for each level of detail level; performing feature-adaptive subdivision and apply the decoded displacements; and reconstructing a mesh frame, based on the feature-adaptive subdivision and the applied decoded displacements.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number, and may be case insensitive):
2D two-dimensional
3D three-dimensional
3DG 3D graphics
3DoF+ three degrees of freedom with additional limited translational movement along the X, Y, and Z axes
6DoF six degrees of freedom
A-B-C feature line including at least point A, point B, and point C (the feature line can contain more than the three points A, B, and C)
ASIC application specific integrated circuit
AVC advanced video coding
BMCL base mesh coding layer
CfP call for proposal
CPU central processing unit
CVS coded V3C sequence
esic edge subdivision iteration count
Exp exponential
fl(n) float using n bits
FoV field of view
fp feature point
FPGA field programmable gate array
fpsic feature point subdivision iteration count
GPU graphics processing unit
H.2xx family of video coding standards in the domain of the ITU-T (e.g. H.263, H.264, H.265, H.266)
HEVC high efficiency video coding
ID identifier
IEC international electrotechnical commission
I/F interface
I/O input/output
ISO International Organization for Standardization
ITU International Telecommunication Union
ITU-T ITU Telecommunication Standardization Sector
LoD, LOD level of detail
MIV MPEG immersive video
MPEG moving picture experts group
NAL network abstraction layer
N/W network
QP quantization parameter
RAM random access memory
RBSP raw byte sequence payload
RGB(D) red green blue, optionally depth
ROM read only memory
SC subcommittee
se(v) signed integer 0-th order Exp-Golomb-coded syntax element with the left bit first.
SEI supplemental enhancement information
SON self-organizing/optimizing network
tsic triangle/triangles subdivision iteration count
u(n) unsigned integer using n bits
ue(v) unsigned integer 0-th order Exp-Golomb-coded syntax element with the left bit first
UI user interface
USB universal serial bus
V3C visual volumetric video-based coding
vdmc, V-DMC video-based dynamic mesh coding
V-PCC video-based point cloud compression
VPS video parameter set
WD working draft
WG working group

What is claimed is:

1. An apparatus comprising: at least one processor; and at least one memory storing instructions that, when executed by the at least one processor, cause the apparatus at least to: receive a bitstream comprising a mesh sequence of an object or a scene; determine a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; determine a patch associated with the mesh sequence; and decode, from or along the bitstream, the mesh sequence of the image or the video, based on the subdivision iteration count for the at least one primitive of the mesh sequence of the image or the video.

2. The apparatus of claim 1, wherein the instructions, when executed by the at least one processor, cause the apparatus at least to: determine whether the at least one primitive is connected to the at least one feature point; determine at least one subdivision iteration count of the respective at least one feature point; determine a subdivision iteration count of the patch associated with the mesh sequence; determine the subdivision iteration count for the at least one primitive of the mesh sequence to be a larger of: the at least one subdivision iteration count of the respective at least one feature point, and the subdivision iteration count of the patch associated with the mesh sequence.

3. The apparatus of claim 1, wherein the instructions, when executed by the at least one processor, cause the apparatus at least to: determine a first subdivision iteration count of a first triangle and a second subdivision iteration count of a second triangle that shares an edge with the first triangle; determine an absolute value of a difference between the first subdivision iteration count of the first triangle having the edge and the second subdivision iteration count of the second triangle having the edge; determine, from among the first triangle and the second triangle, a triangle having a smaller of the first subdivision iteration count and the second subdivision iteration count; and process the triangle having the smaller of the first subdivision iteration count and the second subdivision iteration count as a transition triangle, in response to the absolute value of the difference between the first subdivision iteration count of the first triangle having the edge and the second subdivision iteration count of the second triangle having the edge being one.

4. The apparatus of claim 1, wherein the instructions, when executed by the at least one processor, cause the apparatus at least to: determine a first subdivision iteration count of an edge of at least one triangle, wherein the edge begins with a first vertex and ends with a second vertex; and determine a second subdivision iteration count of the edge of the at least one triangle, wherein the edge begins with the second vertex and ends with the first vertex, wherein the first subdivision iteration count and the second subdivision iteration count are the same or different.

5. The apparatus of claim 1, wherein the instructions, when executed by the at least one processor, cause the apparatus at least to: determine whether an edge of at least one triangle given with a first vertex and a second vertex contains the at least one feature point at the first vertex or the second vertex, or between the first vertex and the second vertex; determine at least one subdivision iteration count of the respective at least one feature point; determine a subdivision iteration count of the patch associated with the mesh sequence; determine a subdivision iteration count for the edge of the at least one triangle given with the first vertex and the second vertex to be a larger of the at least one subdivision iteration count of the respective at least one feature point, and the subdivision iteration count of the patch associated with the mesh sequence, in response to the edge of the at least one triangle given with the first vertex and the second vertex containing the at least one feature point at the first vertex or the second vertex, or the at least one feature point being between the first vertex and the second vertex.

6. The apparatus of claim 1, wherein the instructions, when executed by the at least one processor, cause the apparatus at least to: determine the subdivision iteration count for the at least one primitive for faces that are not connected to an edge with an edge subdivision iteration count different from a subdivision iteration count of the patch associated with the mesh sequence to be the subdivision iteration count of the patch associated with the mesh sequence.

7. The apparatus of claim 1, wherein the instructions, when executed by the at least one processor, cause the apparatus at least to: determine at least one edge subdivision iteration count of at least one edge of a triangle of the mesh sequence; determine a subdivision iteration count for the triangle of the mesh sequence to be a subdivision iteration count of the patch associated with the mesh sequence, in response to the at least one edge subdivision iteration count of one or two edges of the triangle, and not more than two edges of the triangle, being different from the subdivision iteration count of the patch associated with the mesh sequence; and determine the subdivision iteration count for the triangle of the mesh sequence to be a smaller of the respective at least one edge subdivision iteration count of three edges of the triangle, in response to the respective at least one edge subdivision iteration count of the three edges of the triangle being different from the subdivision iteration count of the patch associated with the mesh sequence.

8. The apparatus of claim 1, wherein the instructions, when executed by the at least one processor, cause the apparatus at least to: determine at least one edge subdivision iteration count of at least one edge of a triangle of the mesh sequence; and process a triangle of the mesh sequence as a transition triangle, in response to a subdivision iteration count of the triangle being different from the at least one edge subdivision iteration count of the at least one edge of the triangle of the mesh sequence.

9. The apparatus of claim 1, wherein the instructions, when executed by the at least one processor, cause the apparatus at least to: determine an edge of at least one triangle given with a first vertex and a second vertex; determine a midpoint of the edge given with the first vertex and the second vertex; determine whether a feature point of the edge is closer to the first vertex, the second vertex, or is at a midpoint of the edge between the first vertex and the second vertex; and determine whether to create another vertex or add another edge, based on whether the feature point of the edge is closer to the first vertex, the second vertex, or is at a midpoint of the edge between the first vertex and the second vertex.

10. The apparatus of claim 9, wherein the instructions, when executed by the at least one processor, cause the apparatus at least to: create a third vertex at a midpoint of an edge given with the second vertex and a fourth vertex, creating an edge given with the midpoint of the edge given with the first vertex and the second vertex and the third vertex, in response to the feature point being closer to the second vertex; create a fifth vertex at a midpoint of an edge given with the second vertex and a sixth vertex, creating an edge given with the midpoint of the edge given with the first vertex and the second vertex and the fifth vertex, in response to the feature point being closer to the second vertex; add an edge given with the midpoint of the edge given with the first vertex and the second vertex and the fourth vertex, due to a triangle given with the first vertex, the second vertex, and the fourth vertex being a transition triangle; and add an edge given with the midpoint of the edge given with the first vertex and the second vertex and the sixth vertex, due to a triangle given with the first vertex, the second vertex, and the sixth vertex being a transition triangle.

11. The apparatus of claim 9, wherein the instructions, when executed by the at least one processor, cause the apparatus at least to: create a third vertex at a midpoint of an edge given with the first vertex and a fourth vertex, creating an edge given with the midpoint of the edge given with the first vertex and the second vertex and the third vertex, and create a fifth vertex at a midpoint of an edge given with the second vertex and the fourth vertex, creating an edge given with the midpoint of the edge given with the first vertex and the second vertex and the fifth vertex, and creating an edge between the third vertex and the fifth vertex, in response to the feature point being at the midpoint of the edge given with the first vertex and the second vertex; and create a sixth vertex at a midpoint of an edge given with the first vertex and a seventh vertex, creating an edge given with the midpoint of the edge given with the first vertex and the second vertex and the sixth vertex, and create an eighth vertex at a midpoint of an edge given with the second vertex and the seventh vertex, creating an edge given with the midpoint of the edge given with the first vertex and the second vertex and the eighth vertex, and creating an edge between the sixth vertex and the eight vertex, in response to the feature point being at the midpoint of the edge given with the first vertex and the second vertex.

12. The apparatus of claim 9, wherein the instructions, when executed by the at least one processor, cause the apparatus at least to: create a third vertex at a midpoint of an edge given with the first vertex and a fourth vertex, creating an edge given with the midpoint of the edge given with the first vertex and the second vertex and the third vertex, in response to the feature point being closer to the first vertex; create a fifth vertex at a midpoint of an edge given with the first vertex and a sixth vertex, creating an edge given with the midpoint of the edge given with the first vertex and the second vertex and the fifth vertex, in response to the feature point being closer to the first vertex; add an edge given with the midpoint of the edge given with the first vertex and the second vertex and the fourth vertex, due to a triangle given with the first vertex, the second vertex, and the fourth vertex being a transition triangle; and add an edge given with the midpoint of the edge given with the first vertex and the second vertex and the sixth vertex, due to a triangle given with the first vertex, the second vertex, and the sixth vertex being a transition triangle.

13. The apparatus of claim 1, wherein the instructions, when executed by the at least one processor, cause the apparatus at least to: determine a first subdivision iteration count of a first edge of a triangle of the mesh sequence; determine a second subdivision iteration count of a second edge of the triangle of the mesh sequence; determine a difference between the first subdivision iteration count of the first edge of the triangle of the mesh sequence, and the second subdivision iteration count of the second edge of the triangle of the mesh sequence; repeat a feature adaptive process iteratively following triangle feature adaptive subdivision, or edge feature adaptive subdivision, or vertex feature adaptive subdivision until a largest subdivision iteration count is met, in response to the difference between the first subdivision iteration count of the first edge of the triangle of the mesh sequence, and the second subdivision iteration count of the second edge of the triangle of the mesh sequence being larger than one.

14. The apparatus of claim 1, wherein the instructions, when executed by the at least one processor, cause the apparatus at least to: assign a subdivision iteration count for the at least one primitive of the mesh sequence, and a subdivision iteration count for the at least one feature point.

15. The apparatus of claim 14, wherein the instructions, when executed by the at least one processor, cause the apparatus at least to: determine, based on the subdivision iteration count for the at least one primitive of the mesh sequence, and the subdivision iteration count for the at least one feature point: a vertex associated with a first level of detail, whether to add a vertex associated with a second level of detail with displacement, whether to add a vertex associated with a third level of detail with displacement, whether to add an edge per level of detail, and whether to add an edge for an inter level of detail transition.

16. An apparatus comprising: at least one processor; and at least one memory storing instructions that, when executed by the at least one processor, cause the apparatus at least to: receive a mesh sequence of an object or a scene; determine at least one feature point associated with at least one primitive of the mesh sequence; determine a patch associated with the mesh sequence; determine a subdivision iteration count for the at least one primitive of the mesh sequence, based on the at least one feature point associated with the at least one primitive of the mesh sequence; and encode the mesh sequence into or along a bitstream, based on the subdivision iteration count for the at least one primitive of the mesh sequence.

17. The apparatus of claim 16, wherein the instructions, when executed by the at least one processor, cause the apparatus at least to: determine whether the at least one primitive is connected to the at least one feature point; determine at least one subdivision iteration count of the respective at least one feature point; determine a subdivision iteration count of the patch associated with the mesh sequence; determine the subdivision iteration count for the at least one primitive of the mesh sequence to be a larger of: the at least one subdivision iteration count of the respective at least one feature point, and the subdivision iteration count of the patch associated with the mesh sequence.

18. The apparatus of claim 16, wherein the instructions, when executed by the at least one processor, cause the apparatus at least to: determine a first subdivision iteration count of a first triangle and a second subdivision iteration count of a second triangle that shares an edge with the first triangle; determine an absolute value of a difference between the first subdivision iteration count of the first triangle having the edge and the second subdivision iteration count of the second triangle having the edge; determine, from among the first triangle and the second triangle, a triangle having a smaller of the first subdivision iteration count and the second subdivision iteration count; and process the triangle having the smaller of the first subdivision iteration count and the second subdivision iteration count as a transition triangle, in response to the absolute value of the difference between the first subdivision iteration count of the first triangle having the edge and the second subdivision iteration count of the second triangle having the edge being one.

19. The apparatus of claim 16, wherein the instructions, when executed by the at least one processor, cause the apparatus at least to: determine a first subdivision iteration count of an edge of at least one triangle, wherein the edge begins with a first vertex and ends with a second vertex; determine a second subdivision iteration count of the edge of the at least one triangle, wherein the edge begins with the second vertex and ends with the first vertex; wherein the first subdivision iteration count and the second subdivision iteration count are the same or different.

20. A method comprising: receiving a bitstream comprising a mesh sequence of an object or a scene; determining a subdivision iteration count for at least one primitive of the mesh sequence of the image or video; wherein the subdivision iteration count for the at least one primitive of the mesh sequence of the image or the video is based on at least one feature point associated with the at least one primitive of the mesh sequence; determining a patch associated with the mesh sequence; and decoding, from or along the bitstream, the mesh sequence of the image or the video, based on the subdivision iteration count for the at least one primitive of the mesh sequence of the image or the video.
